(19) United States
(12) Patent Application Publication
(10) Pub. No.: US 2026/0148587 A1
(43) Pub. Date: May 28, 2026

(54) ELECTRONIC DEVICE CAPABLE OF VISION RECOGNITION AND OPERATING METHOD THEREOF

(71) Applicant: Samsung Electronics Co., Ltd., Suwon-si (KR)

(72) Inventors: Iegor VDOVYCHENKO, Kyiv (UA); Oleksandr SAPOZHNIK, Kyiv (UA); Dmytro KOZII, Kyiv (UA); Vladyslav DYKYI, Kyiv (UA); Alona VITIUK, Kyiv (UA); Andrii TUZHYKOV, Kyiv (UA)

(21) Appl. No.: 19/448,783

(22) Filed: Jan. 14, 2026

Related U.S. Application Data
(63) Continuation of application No. PCT/KR2024/011796, filed on Aug. 8, 2024.

(30) Foreign Application Priority Data
Aug. 11, 2023 (KR) 10-2023-0105762

(51) Int. Cl. G06V 40/20; G06T 3/40; G06T 7/50; G06V 10/77; G06V 40/16

(52) U.S. Cl. CPC G06V 40/28; G06T 3/40; G06T 7/50; G06V 10/7715; G06V 40/172; G06V 40/174

(57) ABSTRACT

An electronic device is provided. The electronic device includes a first vision sensor configured to obtain visual data, memory storing instructions, and at least one processor, wherein the instructions, when executed by the at least one processor individually or collectively, cause the electronic device to obtain the visual data from the first vision sensor, based on a requirement of a designated vision engine, transform at least one component of the visual data, and based on the visual data with the at least one component transformed, perform vision recognition using the designated vision engine.

### CROSS-REFERENCE TO RELATED APPLICATION(S)

This application is a continuation application, claiming priority under 35 U.S.C. § 365(c), of an International application No. PCT/KR2024/011796, filed on Aug. 8, 2024, which is based on and claims the benefit of a Korean patent application number 10-2023-0105762, filed on Aug. 11, 2023, in the Korean Intellectual Property Office, the disclosure of which is incorporated by reference herein in its entirety.

### BACKROUND

### 1. FIELD

The disclosure relates to an electronic device capable of vision recognition and an operating method thereof according to an embodiment.

### 2. Description of Related Art

With the development of electronic device technology, various types of electronic devices, such as mobile communication terminals, personal digital assistants (PDAs), electronic schedulers, smartphones, tablet personal computers (PCs), and wearable devices, are in wide use. For example, electronic devices may provide virtual reality (VR), which allows users to have a realistic experience in a computer-generated virtual world, augmented reality (AR), which adds virtual information (or objects) to the real world, or mixed reality (MR), which combines virtual reality and augmented reality.

Wearable electronic devices that are used while being worn on users, such as head-mounted devices, require compact space utilization and may need technology for providing light corresponding to the display of a screen on the display to the users'eyes through lenses for space utilization purposes.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device capable of vision recognition and operating method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a first vision sensor configured to obtain visual data, memory, storing instructions, and at least one processor, wherein the instructions, when executed by the at least one processor individually or collectively, cause the electronic device to obtain the visual data from the first vision sensor, based on a requirement of a designated vision engine, transform at least one component of the visual data, and based on the visual data with the at least one component transformed, perform vision recognition using the designated vision engine.

In accordance with another aspect of the disclosure, A method performed by an electronic device is provided. The method includes obtaining, by the electronic device, visual data from a first vision sensor, based on a requirement of a designated vision engine, transforming, by the electronic device, at least one component of the visual data, and based on the visual data with the at least one component transformed, performing, by the electronic device, vision recognition using the designated vision engine.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include obtaining, by the electronic device, visual data from a first vision sensor, based on a requirement of a designated vision engine, transforming, by the electronic device, at least one component of the visual data, and based on the visual data with the at least one component transformed, performing, by the electronic device, vision recognition using the designated vision engine.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a perspective view illustrating an internal configuration of a wearable device according to an embodiment of the disclosure;

FIGS. 3A and 3B are views illustrating front and rear surfaces of a wearable electronic device according to various embodiments of the disclosure;

FIG. 4 is a block diagram illustrating an electronic device according to an embodiment of the disclosure;

FIGS. 5A, 5B, 5C, 5D, and 5E illustrate visual data according to various embodiments of the disclosure;

FIG. 6 illustrates adaptation of visual data according to an embodiment of the disclosure;

FIG. 7 is a flowchart illustrating an operating method of an electronic device according to an embodiment of the disclosure;

FIG. 8 is a flowchart illustrating performing initial evaluation of FIG. 7 according to an embodiment of the disclosure;

FIG. 9 is a flowchart illustrating transforming at least one component of visual data of FIG. 7 according to an embodiment of the disclosure;

FIG. 10 illustrates an example of transforming a color profile of visual data according to an embodiment of the disclosure;

FIG. 11 illustrates an example of adjusting parameters related to color of visual data according to an embodiment of the disclosure;

FIGS. 12 and 13 illustrate examples of fusing comparison data with visual data according to various embodiments of the disclosure;

FIG. 14 illustrates an example of fusing comparison data with visual data according to an embodiment of the disclosure;

FIG. 15 illustrates an example of data transformation for an image according to an embodiment of the disclosure;

FIG. 16 illustrates an example of feature integration for evaluation of visual data according to an embodiment of the disclosure;

FIG. 17 illustrates an example of upscaling of an image according to an embodiment of the disclosure;

FIGS. 18 and 19 are examples of color adjustment and resulting hand detection according to various embodiments of the disclosure;

FIGS. 20 and 21 are examples of feature extraction and resulting vision recognition according to various embodiments of the disclosure;

FIG. 22A illustrates an example of hand detection through vision recognition according to an embodiment of the disclosure;

FIGS. 22B, 22C, and 22D are application examples of hand detection according to various embodiments of the disclosure;

FIGS. 23A and 23B illustrate examples of facial recognition through vision recognition according to various embodiments of the disclosure;

FIG. 24 illustrates an example of transforming visual data to correspond to requirements of a vision engine according to an embodiment of the disclosure;

FIG. 25 illustrates an example of correcting a distortion model of visual data according to an embodiment of the disclosure;

FIG. 26 illustrates an example of recognizing a subject according to an embodiment of the disclosure;

FIGS. 27A and 27B illustrate examples of providing a metaverse according to various embodiments of the disclosure;

FIG. 28 illustrates an example of transformation to a point cloud according to an embodiment of the disclosure; and

FIGS. 29 and 30 illustrate examples of transformation of visual data according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi™) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

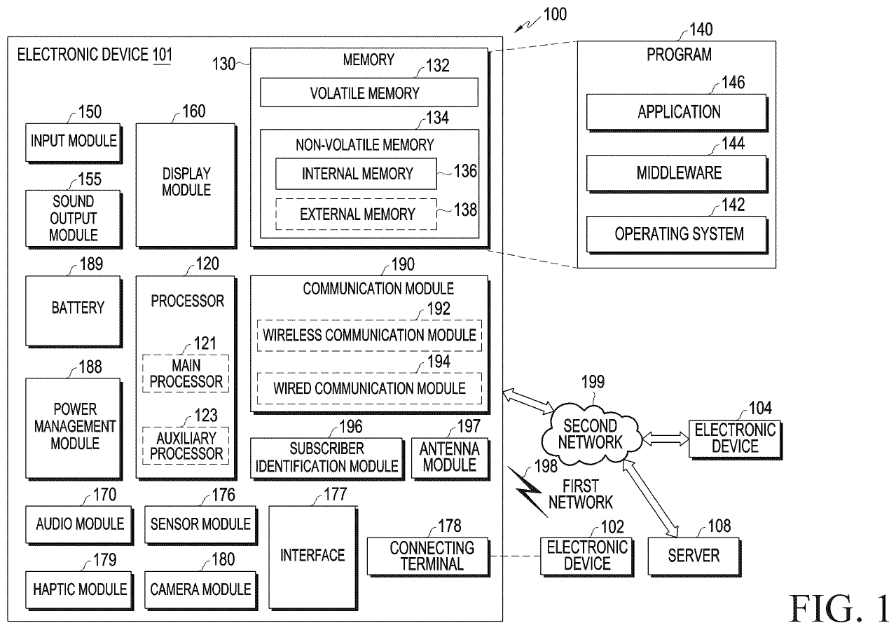

FIG. 1 is a block diagram illustrating an electronic device in a network environment according to an embodiment of the disclosure.

Referring to FIG. 1, an electronic device 101 in a network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi™) direct, or infrared data association (IrDA)) or the second network 199 (e.g., a long-range communication network, such as a legacy cellular network, a fifth-generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices (e.g., the electronic devices 102 and 104 and the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

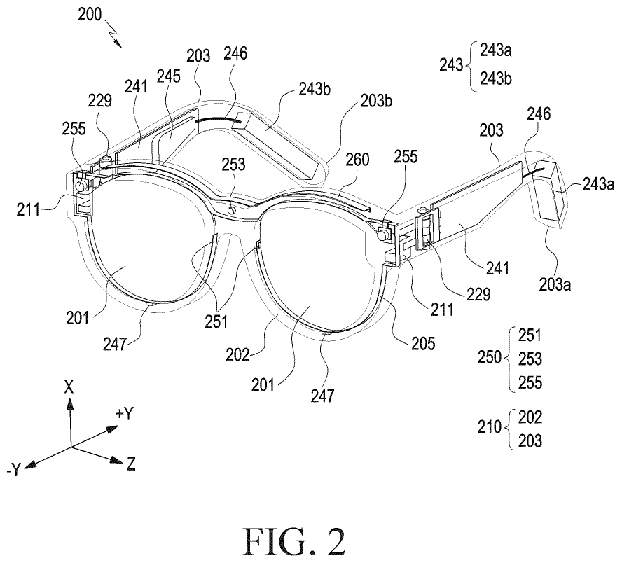

FIG. 2 is a perspective view illustrating an internal configuration of a wearable device according to an embodiment of the disclosure.

Referring to FIG. 2, a wearable device 200 may be a glasses-type electronic device, and the user may visually recognize her surrounding objects or environment while wearing the wearable device 200. For example, the wearable device 200 may be a head-mounted device (HMD) or smart glasses capable of providing images directly in front of the user's eyes. The configuration of the wearable device 200 of FIG. 2 may be identical in whole or part to the configuration of the electronic device 101 of FIG. 1.

According to an embodiment, the wearable device 200 may include a housing that forms the exterior of the wearable device 200. A housing 210 may provide a space in which components of the wearable device 200 may be disposed. For example, the housing 210 may include a lens frame 202 and at least one wearing member 203.

According to an embodiment, the wearable device 200 may include a display member 201 capable of providing the user with visual information. For example, the display member 201 may include a module equipped with a lens or a second window member, a display, a waveguide, and/or a touch circuit. According to an embodiment, the display member 201 may be transparent or semi-transparent. According to an embodiment, the display member 201 may include a semi-transparent glass or a window member the light transmittance of which may be adjusted as the coloring concentration is adjusted. According to an embodiment, a pair of display members 201 may be provided and disposed to correspond to the user's left and right eyes, respectively, with the wearable device 200 worn on the user's body.

According to an embodiment, the lens frame 202 may receive at least a portion of the display member 201. For example, the lens frame 202 may surround at least a portion of the display member 201. According to an embodiment, the lens frame 202 may position at least one of the display members 201 to correspond to the user's eye. According to an embodiment, the lens frame 202 may be the rim of a normal eyeglass structure. According to an embodiment, the lens frame 202 may include at least one closed loop surrounding the display members 201.

According to an embodiment, the wearing members 203 may extend from the lens frame 202. For example, the wearing members 203 may extend from ends of the lens frame 202 and, together with the lens frame 202, may be supported and/or positioned on a part (e.g., ears) of the user's body. According to an embodiment, the wearing members 203 may be rotatably coupled to the lens frame 202 through hinge structures 229. According to an embodiment, the wearing member 203 may include an inner side surface 231c configured to face the user's body and an outer side surface 231d opposite to the inner side surface.

According to an embodiment, the wearable device 200 may include the hinge structures 229 configured to fold the wearing members 203 on the lens frame 202. The hinge structure 229 may be disposed between the lens frame 202 and the wearing member 203. While the wearable device 200 is not worn, the user may fold the wearing members 203 on the lens frame 202 to carry or store the electronic device.

The wearable device 200 may include components received in the housing 210 (e.g., at least one circuit board 241 (e.g., printed circuit board (PCB), printed board assembly (PBA), flexible PCB, or rigid-flexible PCB (RFPCB)), at least one battery 243, at least one speaker module 245, at least one power transfer structure 246, and a camera module 250). The configuration of the housing 210 of FIG. 2B may be identical in whole or part to the configuration of the display member 201, the lens frame 202, the wearing members 203, and the hinge structures 229 of FIG. 2A.

According to an embodiment, the wearable device 200 may obtain and/or recognize a visual image regarding an object or environment in the direction (e.g., −Y direction) in which the wearable device 200 faces or the direction in which the user gazes, using the camera module 250 (e.g., the camera module 180 of FIG. 1) and may receive information regarding the object or environment from an external electronic device (e.g., the electronic device 102 or 104 or the server 108 of FIG. 1) through a network (e.g., the first network 198 or second network 199 of FIG. 1). In another embodiment, the wearable device 200 may provide the received object- or environment-related information, in the form of an audio or visual form, to the user. The wearable device 200 may provide the received object- or environment-related information, in a visual form, to the user through the display members 201, using the display module (e.g., the display module 160 of FIG. 1). For example, the wearable device 200 may implement augmented reality (AR) by implementing the object- or environment-related information in a visual form and combining it with an actual image of the user's surrounding environment.

According to an embodiment, the display member 201 may include a first surface F1 facing in a direction (e.g., −Y direction) in which external light is incident and a second surface F2 facing in a direction (e.g., +Y direction) opposite to the first surface F1. With the user wearing the wearable device 200, at least a portion of the light or image coming through the first surface F1 may be incident on the user's left eye and/or right eye through the second surface F2 of the display member 201 disposed to face the user's left eye and/or right eye.

According to an embodiment, the lens frame 202 may include at least two or more frames. For example, the lens frame 202 may include a first frame 202a and a second frame 202b. According to an embodiment, when the user wears the wearable device 200, the first frame 202a may be a frame of the portion facing the user's face, and the second frame 202b may be a portion of the lens frame 202 spaced from the first frame 202a in the gazing direction (e.g., −Y direction) in which the user gazes.

According to an embodiment, a light output module 211 may provide an image and/or video to the user. For example, the light output module 211 may include a display panel (not shown) capable of outputting images and a lens (not shown) corresponding to the user's eye and guiding images to the display member 201. For example, the user may obtain the image output from the display panel (not shown) of the light output module 211 through the lens (not illustrated) of the light output module 211.

According to an embodiment, the light output module 211 may include a display panel (not illustrated) configured to display various information. For example, the display panel (not illustrated) may include at least one of a liquid crystal display (LCD), a digital mirror device (DMD), a liquid crystal on silicon (LCoS), or an organic light emitting diode (OLED), or a micro light emitting diode (micro LED). According to an embodiment, when the display panel (not illustrated) and/or the light output module 211 includes one of a liquid crystal display device, a digital mirror display device, or a silicon liquid crystal display device, the wearable device 200 may include a light output module 211 and/or a light source emitting light to the display area of the display member 201.

According to an embodiment, when the display panel (not illustrated) and/or the light output module 211 includes organic light emitting diodes or micro LEDs, the wearable device 200 may provide virtual images to the user without a separate light source. According to an embodiment, if the display panel (not illustrated) is implemented with organic light emitting diodes (OLEDs) or micro LEDs, a light source is unnecessary, so the wearable device 200 may be made lightweight.

According to an embodiment, the lens (not illustrated) may serve to adjust focus so that a screen output to a display panel (not illustrated) may be illustrated to a user's eyes. For example, the lens (not illustrated) may be composed of a Fresnel lens, a Pancake lens, or a multi-channel lens.

According to an embodiment, the waveguide may serve to transfer light generated from a display panel (not illustrated) to a user's eyes. For example, the waveguide may be formed of glass, plastic, or polymer, and may include a nano pattern formed on some internal or external surfaces, e.g., a grating structure of polygonal or curved shape. According to an embodiment, light incident on one end of the waveguide may propagate inside the waveguide by the nano pattern and be provided to a user. Further, the waveguide composed of a free-form prism may provide incident light to a user through a reflective mirror. In an embodiment, the waveguide may include at least one of at least one diffractive element (e.g., diffractive optical element (DOE), holographic optical element (HOE)) or a reflective element (e.g., reflective mirror). In an embodiment, the waveguide may guide light from a display panel (not illustrated) emitted from a light source to a user's eyes using at least one diffractive element or reflective element.

According to an embodiment, the diffractive element may include an input optical member (not illustrated)/output optical member (not illustrated). For example, the input optical member (not illustrated) may refer to an input grating area, and an output optical member (not illustrated) may refer to an output grating area. The input grating area may serve as an input stage diffracting (or reflecting) light to transfer light output from a light source (e.g., Micro LED) to a transparent member (e.g., first transparent member, second transparent member) of a screen display unit. The output grating area may serve as an exit diffracting (or reflecting) light transferred to a display member 201 of the waveguide to a user's eyes.

According to an embodiment, a reflective element may include a total internal reflection (TIR) optical element (not illustrated) or a total internal reflection waveguide (not illustrated) for total internal reflection. For example, total internal reflection is a method of guiding light, which may mean creating an incident angle so that light (e.g., virtual image) input through the input grating area is 100% reflected on one surface (e.g., specific surface) of the waveguide, allowing 100% transmission to the output grating area.

In an embodiment, light emitted from a display panel (not illustrated) may have its light path guided to the waveguide through an input optical member. Light moving inside the waveguide may be guided toward a user's eyes through an output optical member. The screen display unit may be determined based on the light emitted in the direction to the eye.

According to an embodiment, at least a portion of the light output module 211 may be disposed in the housing 210. For example, the light output module 211 may be disposed in the wearing member 203 or the lens frame 202 to correspond to each of the user's right eye and left eye. According to an embodiment, the light output module 211 may be connected to the display member 201 and may provide images to the user through the display member 201.

According to an embodiment, the circuit board 241 may include components for driving the wearable device 200. For example, the circuit board 241 may include at least one integrated circuit chip. Further, at least one of the processor 120, the memory 130, the power management module 188, or the communication module 190 of FIG. 1 may be provided in the integrated circuit chip. According to an embodiment, a circuit board 241 may be disposed in the wearing member 203 of the housing 210. According to an embodiment, the circuit board 241 may be electrically connected to the battery 243 through the power transfer structure 246. According to an embodiment, the circuit board 241 may be connected to the flexible printed circuit board 205 and may transfer electrical signals to the electronic components (e.g., the light output module 211, the camera module 250, and the light emitting unit) of the electronic device through the flexible printed circuit board 205. According to an embodiment, the circuit board 241 may be a circuit board including an interposer.

According to various embodiments, the flexible printed circuit board 205 may extend from the circuit board 241 through the hinge structure 229 to the inside of the lens frame 202 and may be disposed in at least a portion of the inside of the lens frame 202 around the display member 201.

According to an embodiment, the battery 243 (e.g., the battery 189 of FIG. 1) may be connected with components (e.g., the light output module 211, the circuit board 241, and the speaker module 245, a microphone module 247, and the camera module 250) of the wearable device 200 and may supply power to the components of the wearable device 200.

According to an embodiment, at least a portion of the battery 243 may be disposed in the wearing member 203. According to an embodiment, batteries 243 may be disposed in ends 203a and 203b of the wearing members 203. For example, the batteries 243 may include a first battery 243a disposed in a first end 203a of the wearing member 203 and a second battery 243b disposed in a second end 203b of the wearing member 203.

According to various embodiments, the speaker module 245 (e.g., the audio module 170 or the sound output module 155 of FIG. 1) may convert an electrical signal into sound. At least a portion of the speaker module 245 may be disposed in the wearing member 203 of the housing 210. According to an embodiment, the speaker module 245 may be located in the wearing member 203 to correspond to the user's ear. For example, the speaker module 245 may be disposed between the circuit board 241 and the battery 243.

According to an embodiment, the power transfer structure 246 may transfer the power from the battery 243 to an electronic component (e.g., the light output module 211) of the wearable device 200. For example, the power transfer structure 246 may be electrically connected to the battery 243 and/or the circuit board 241, and the circuit board 241 may transfer the power received through the power transfer structure 246 to the light output module 211. According to an embodiment, the power transfer structure 246 may be connected to the circuit board 241 through the speaker module 245. For example, when the wearable device 200 is viewed from a side (e.g., in the Z-axis direction), the power transfer structure 246 may at least partially overlap the speaker module 245.

According to an embodiment, the power transfer structure 246 may be a component capable of transferring power. For example, the power transfer structure 246 may include a flexible printed circuit board or wiring. For example, the wiring may include a plurality of cables (not shown). In various embodiments, various changes may be made to the shape of the power transfer structure 246 considering the number and/or type of the cables.

According to an embodiment, the microphone module 247 (e.g., the input module 150 and/or the audio module 170 of FIG. 1) may convert a sound into an electrical signal. According to an embodiment, the microphone module 247 may be disposed in at least a portion of the lens frame 202. For example, at least one microphone module 247 may be disposed on a lower end (e.g., in the −X-axis direction) and/or on an upper end (e.g., in the X-axis direction) of the wearable device 200. According to an embodiment, the wearable device 200 may more clearly recognize the user's voice using voice information (e.g., sound) obtained by the at least one microphone module 247. For example, the wearable device 200 may distinguish the voice information from the ambient noise based on the obtained voice information and/or additional information (e.g., low-frequency vibration of the user's skin and bones). For example, the wearable device 200 may clearly recognize the user's voice and may perform a function of reducing ambient noise (e.g., noise canceling).

According to an embodiment, the camera module 250 may capture a still image and/or a video. The camera module 250 may include at least one of a lens, at least one image sensor, an image signal processor, or a flash. According to an embodiment, the camera module 250 may be disposed in the lens frame 202 and may be disposed around the display member 201.

According to an embodiment, the camera module 250 may include a light emitting unit that may be attached at various positions. In an embodiment, the light emitting unit may be used as an auxiliary means to facilitate detection of a user's gaze through a first camera module 251. In an embodiment, it may be attached around the hinge structure 229 connecting the lens frame 202 and the wearing member 203, or adjacent to a second camera module 253 disposed between the lens frame 202, and may be used as the means to supplement ambient brightness during photography. In particular, the light emitting unit may be effective when subject detection is not easy in a dark environment.

According to an embodiment, the camera module 250 may include at least one first camera module 251. According to an embodiment, the first camera module 251 may capture the trajectory of the user's eye (e.g., a pupil) or gaze. For example, the first camera module 251 may capture the reflection pattern of the light emitted by the light emitting unit to the user's eyes. For example, the light emitting unit may emit light in an infrared band for tracking the trajectory of the gaze using the first camera module 251. For example, the light emitting unit may include an IR LED. According to an embodiment, the processor (e.g., the processor 120 of FIG. 1) may adjust the position of the virtual image so that the virtual image projected on the display member 201 corresponds to the direction in which the user's pupil gazes. According to an embodiment, the first camera module 251 may include a global shutter (GS)-type camera. It is possible to track the trajectory of the user's eyes or gaze using a plurality of first camera modules 251 having the same specifications and performance.

According to various embodiments, the first camera module 251 may periodically or aperiodically transmit information related to the trajectory of the user's eye or gaze (e.g., trajectory information) to the processor (e.g., the processor 120 of FIG. 1). According to another embodiment, when the first camera module 251 detects a change in the user's gaze based on the trajectory information (e.g., when the user's eyes move more than a reference value with the head positioned still), the first camera module 251 may transmit the trajectory information to the processor.

According to various embodiments, the camera modules 250 may include at least one second camera module 253. According to an embodiment, the second camera module 253 may capture an external image. According to an embodiment, the second camera module 253 may be a global shutter-type or rolling shutter (RS)-type camera. According to an embodiment, the second camera module 253 may capture an external image through the second optical hole 223 formed in the second frame 202b. For example, the second camera module 253 may include a high-resolution color camera, and it may be a high resolution (HR) or photo video (PV) camera. Further, the second camera module 253 may provide an auto-focus (AF) function and an optical image stabilizer (OIS) function. The second camera module 253 according to an embodiment of the disclosure may include one or more cameras.

According to an embodiment, the wearable device 200 may include a flash (not shown) positioned adjacent to the second camera module 253. For example, the flash (not shown) may provide light for increasing brightness (e.g., illuminance) around the wearable device 200 when an external image is obtained by the second camera module 253, thereby reducing difficulty in obtaining an image due to the dark environment, the mixing of various light beams, and/or the reflection of light.

According to an embodiment, the camera modules 250 may include at least one third camera module 255. According to an embodiment, the third camera module 255 may capture a user's motion or recognize space through a first optical hole 221 formed in a lens frame 202. For example, the third camera module 255 may detect a user's hand to capture a user's gesture (e.g., hand motion). For example, the third camera module 255 may track movement of a user's head or recognize surrounding space.

According to an embodiment, the third camera module 255 and/or the first optical hole 221 may be disposed at both side ends of a lens frame 202 (e.g., second frame 202b), e.g., at two opposite ends of the lens frame 202 (e.g., second frame 202b) in the X direction. According to an embodiment, the third camera module 255 may be a global shutter (GS)-type camera. For example, the third camera module 255 may be a camera supporting 3 degrees of freedom (DoF) or 6DoF, which may provide position recognition and/or motion recognition in a 360-degree space (e.g., omni-directionally).

According to an embodiment, the third camera modules 255 may be stereo cameras and may perform the functions of simultaneous localization and mapping (SLAM) and user motion recognition using a plurality of global shutter (GS)-type cameras with the same specifications and performance. According to an embodiment, the third camera module 255 may include an infrared (IR) camera (e.g., a time of flight (ToF) camera or a structured light camera). For example, the IR camera may be operated as at least a part of a sensor module (e.g., the sensor module 176 of FIG. 1) for detecting a distance from the subject.

According to an embodiment, at least one of the first camera module 251 or the third camera module 255 may be replaced with a sensor module (e.g., the sensor module 176 of FIG. 1) (e.g., lidar sensor). For example, the sensor module may include at least one of a vertical cavity surface emitting laser (VCSEL), an infrared sensor, and/or a photodiode. For example, the photodiode may include a positive intrinsic negative (PIN) photodiode or an avalanche photodiode (APD). The photodiode may be referred to as a photo detector or a photo sensor.

According to an embodiment, at least one of the first camera module 251, the second camera module 253, and the third camera module 255 may include a plurality of camera modules (not shown). For example, the second camera module 253 may include a plurality of lenses (e.g., wide-angle and telephoto lenses) and image sensors and may be disposed on one surface (e.g., a surface facing in the −Y axis) of the wearable device 200. For example, the wearable device 200 may include a plurality of camera modules having different properties (e.g., angle of view) or functions and control to change the angle of view of the camera module based on the user's selection and/or trajectory information. At least one of the plurality of camera modules may be a wide-angle camera and at least another of the plurality of camera modules may form a telephoto camera.

According to various embodiments, the processor (e.g., processor 120 of FIG. 1) may determine the motion of the wearable device 200 and/or the user's motion using information for the wearable device 200 obtained using at least one of a gesture sensor, a gyro sensor, or an acceleration sensor of the sensor module (e.g., the sensor module 176 of FIG. 1) and the user's action (e.g., approach of the user's body to the wearable device 200) obtained using the first camera module 251. According to an embodiment, in addition to the above-described sensor, the wearable device 200 may include a magnetic (geomagnetic) sensor capable of measuring an orientation using a magnetic field and magnetic force lines and/or a hall sensor capable of obtaining motion information (e.g., moving direction or distance) using the strength of a magnetic field. For example, the processor may determine the motion of the wearable device 200 and/or the user's motion based on information obtained from the magnetic (geomagnetic) sensor and/or the hall sensor.

According to various embodiments (not shown), the wearable device 200 may perform an input function (e.g., a touch and/or pressure sensing function) capable of interacting with the user. For example, a component configured to perform a touch and/or pressure sensing function (e.g., a touch sensor and/or a pressure sensor) may be disposed in at least a portion of the wearing member 203. The wearable device 200 may control the virtual image output through the display member 201 based on the information obtained through the components. For example, a sensor associated with a touch and/or pressure sensing function may be configured in various types, e.g., a resistive type, a capacitive type, an electro-magnetic (EM) type, or an optical type. According to an embodiment, the component configured to perform the touch and/or pressure sensing function may be identical in whole or part to the configuration of the input module 150 of FIG. 1.

According to an embodiment, the wearable device 200 may including a reinforcing member 260 that is disposed in an inner space of the lens frame 202 and formed to have a higher rigidity than that of the lens frame 202.

According to an embodiment, the wearable device 200 may include a lens structure 270. The lens structure 270 may refract at least a portion of light. For example, the lens structure 270 may be a prescription lens having a predesignated refractive power. According to an embodiment, the lens structure 270 may be disposed behind (e.g., +Y direction) the second window member of the display member 201. For example, the lens structure 270 may be positioned between the display member 201 and the user's eye. For example, the lens structure 270 may face one surface of the display member.

According to an embodiment, the housing 210 may include a hinge cover 227 that may conceal a portion of the hinge structure 229. Another part of the hinge structure 229 may be received or hidden between an inner case 231 and an outer case 233, which are described below.

According to an embodiment, the wearing member 203 may include the inner case 231 and the outer case 233. The inner case 231 may be, e.g., a case configured to face the user's body or directly contact the user's body, and may be formed of a material having low thermal conductivity, e.g., a synthetic resin. According to an embodiment, the inner case 231 may include an inner side surface (e.g., the inner side surface 231c of FIG. 2A) facing the user's body. The outer case 233 may include, e.g., a material (e.g., a metal) capable of at least partially transferring heat and may be coupled to the inner case 231 to face each other. According to an embodiment, the outer case 233 may include an outer side surface (e.g., the outer side surface 231d of FIG. 2A) opposite to the inner side surface 231c. In an embodiment, at least one of the circuit board 241 or the speaker module 245 may be received in a space separated from the battery 243 in the wearing member 203. In the illustrated embodiment, the inner case 231 may include a first case 231a including the circuit board 241 or the speaker module 245 and a second case 231b receiving the battery 243, and the outer case 233 may include a third case 233a coupled to face the first case 231a and a fourth case 233b coupled to face the second case 231b. For example, the first case 231a and the third case 233a may be coupled (hereinafter, ‘first case portions 231a and 233a’) to receive the circuit board 241 and/or the speaker module 245, and the second case 231b and the fourth case 233b may be coupled (hereinafter, ‘second case portions 231b and 233b’) to receive the battery 243.

According to various embodiments, the first case portions 231a and 233a may be rotatably coupled to the lens frame 202 through the hinge structure 229, and the second case portions 231b and 233b may be connected or mounted to the ends of the first case portions 231a and 233a through the connecting member 235. In some embodiments, a portion of the connecting member 235 in contact with the user's body may be formed of a material having low thermal conductivity, e.g., an elastic material, such as silicone, polyurethane, or rubber, and another portion thereof which does not come into contact with the user's body may be formed of a material having high thermal conductivity (e.g., a metal). For example, when heat is generated from the circuit board 241 or the battery 243, the connecting member 235 may block heat transfer to the portion in contact with the user's body while dissipating or discharging heat through the portion not in contact with the user's body. According to an embodiment, a portion of the connecting member 235 configured to come into contact with the user's body may be interpreted as a portion of the inner case 231, and a portion of the connecting member 235 that does not come into contact with the user's body may be interpreted as a portion of the outer case 233. According to an embodiment (not shown), the first case 231a and the second case 231b may be integrally configured without the connecting member 235, and the third case 233a and the fourth case 233b may be integrally configured without the connecting member 235. According to various embodiments, other components (e.g., the antenna module 197 of FIG. 1) than the illustrated components may be included. The communication module 190 may be used to receive information regarding things or environment from an external electronic device (e.g., the electronic device 102 or 104 or the server 108 of FIG. 1) via a network (e.g., the first network 198 or second network 199 of FIG. 1).

Although only the wearable device 200 is illustrated and described in FIG. 2, the disclosure is not limited thereto, and some components of the wearable device 200 illustrated in FIG. 2 may be included in electronic devices, such as smartphones and tablet PCs.

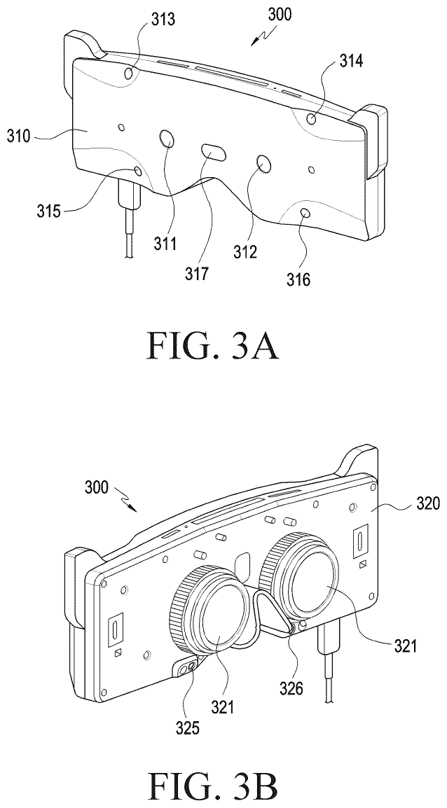

FIGS. 3A and 3B are views illustrating front and rear surfaces of a wearable electronic device according to various embodiments of the disclosure.

Referring to FIGS. 3A and 3B, in an embodiment, camera modules 311, 312, 313, 314, 315, and 316 and/or a depth sensor 317 for obtaining information related to the ambient environment of a wearable electronic device 300 may be disposed on a first surface 310 of the housing.

In an embodiment, the camera modules 311 and 312 may obtain images related to the ambient environment of the wearable electronic device.

In an embodiment, the camera modules 313, 314, 315, and 316 may obtain images while the wearable electronic device is worn by the user. The camera modules 313, 314, 315, and 316 may be used for hand detection, tracking, and recognition of the user gesture (e.g., hand motion). The camera modules 313, 314, 315, and 316 may be used for 3DoF or 6DoF head tracking, location (space or environment) recognition, and/or movement recognition. In an embodiment, the camera modules 311 and 312 may be used for hand detection and tracking and recognition of the user's gesture.

In an embodiment, the depth sensor 317 may be configured to transmit a signal and receive a signal reflected from an object and be used for identifying the distance to the object, such as time of flight (ToF). For example, the depth sensor 317 may measure the distance to a subject using near-infrared, ultrasound, or laser. In an embodiment, the depth sensor 317 may measure time of flight (ToF) of a signal by emitting a signal from a transmitter and measuring the signal at a receiver.

According to an embodiment, camera modules 325 and 326 for face recognition and/or a display 321 (and/or lens) may be disposed on a second surface 320 of the housing.

In an embodiment, the face recognition camera modules 325 and 326 adjacent to the display 321 may be used for recognizing the user's face or may recognize and/or track both eyes of the user. In an embodiment, facial recognition camera modules 325, 326 may detect or track a user's facial expressions.

In an embodiment, the display 321 (and/or lens) may be disposed on the second surface 320 of the wearable electronic device 300. In an embodiment, the wearable electronic device 300 may not include the camera modules 315 and 316 among the plurality of camera modules 313, 314, 315, and 316. Although not shown in FIGS. 3A and 3B, the wearable electronic device 300 may further include at least one of the components shown in FIGS. 2A and 2B.

As described above, according to an embodiment, the wearable electronic device 300 may have a form factor to be worn on the user's head. The wearable electronic device 300 may further include a strap and/or a wearing member to be fixed on the user's body part. The wearable electronic device 300 may provide the user experience based on augmented reality, virtual reality, and/or mixed reality while worn on the user's head.

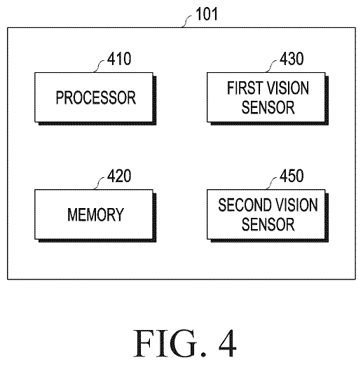

FIG. 4 is a block diagram illustrating an electronic device according to an embodiment of the disclosure.

Referring to FIG. 4, an electronic device 101 (e.g., the electronic device 101 of FIG. 1, the wearable device 200 of FIG. 2A, or the wearable electronic device 300 of FIGS. 3A and 3B) according to an embodiment may include a processor 410, memory 420, a first vision sensor 430, and a second vision sensor 450.

The processor 410 (e.g., the processor 120 of FIG. 1) according to an embodiment may control at least one other component (e.g., hardware or software component) of the electronic device 101. In an embodiment, the processor 410 may perform various data processing or operations, and as at least part of the data processing or operations, the processor 410 may store a command or data received from another component in the memory 420, may process the command or data stored in the memory 420, and may store result data in the memory 420.

The memory 420 (e.g., the memory 130 of FIG. 1) according to an embodiment may store instructions executable by the processor 410.

The processor 410 according to an embodiment may include a designated vision engine that performs vision recognition. In an embodiment, the processor 410 may perform vision recognition corresponding to visual data by inputting visual data to a designated vision engine. In an embodiment, the designated vision engine may provide an artificial intelligence (AI) based vision solution trained using a designated type of visual data.

The first vision sensor 430 (e.g., the sensor module 176 or camera module 180 of FIG. 1) and/or the second vision sensor 450 (e.g., the sensor module 176 or camera module 180 of FIG. 1) according to an embodiment may each be a vision sensor that obtains visual data. In an embodiment, the first vision sensor 430 and the second vision sensor 450 may be the same sensor to obtain the same type of visual data. In an embodiment, the first vision sensor 430 and the second vision sensor 450 may be different types of sensors to obtain different types of visual data from each other.

In an embodiment, visual data may be an image or video. In an embodiment, the first vision sensor 430 and/or the second vision sensor 450 may be a camera sensor that obtains an image or video.

In an embodiment, visual data may be surface data such as a depth map or mesh. In an embodiment, the first vision sensor 430 and/or the second vision sensor 450 may be a depth sensor using time of flight (ToF), Lidar, Stereo pair, or Structured light.

The electronic device 101 according to an embodiment may further include a display (e.g., the display module 160 of FIG. 1, the display member 201 of FIG. 2A, or the display 321 of FIG. 3B) configured to display a screen in front of a user's eyes.

The electronic device 101 according to an embodiment may further include components included in the electronic device 101 of FIG. 1, the wearable device 200 of FIG. 2A, or the wearable electronic device 300 of FIGS. 3A and 3B, in addition to the components illustrated and described, or may exclude some.

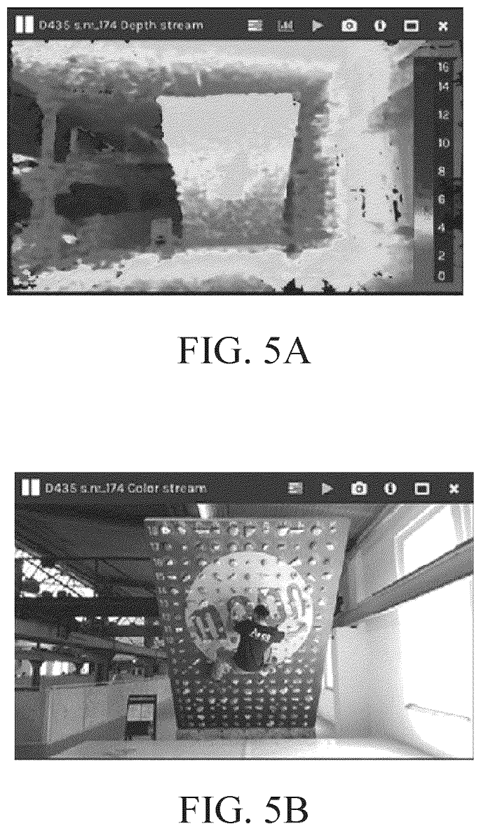

FIGS. 5A, 5B, 5C, 5D, and 5E illustrate visual data according to various embodiments of the disclosure.

Referring to FIGS. 5A, 5B, 5C, 5D, and 5E, the electronic device 101 according to an embodiment may obtain various types of visual data through the first vision sensor 430 and/or the second vision sensor 450.

The electronic device 101 according to an embodiment may obtain various types of visual data such as red green blue (RGB) image data, infrared image data, depth data, point cloud, or hyperspectral image data.

In an embodiment, the electronic device 101 may obtain depth data, RGB image data, and/or point cloud as visual data corresponding to the same scene, respectively, as illustrated in FIGS. 5A, 5B, and 5C. In an embodiment, the electronic device 101 may obtain hyperspectral image data as visual data, as illustrated in FIG. 5D.

The electronic device 101 according to an embodiment may obtain a designated type of visual data corresponding to hardware characteristics of the first vision sensor 430 and/or the second vision sensor 450.

In an embodiment, the electronic device 101 may obtain distorted infrared image data as illustrated in FIG. 5E. For example, there are various distortion models that describe mathematical deviations of a camera in a pinhole model. For example, distortion models include various models such as Polynomial Radial, Brown-Conrady, and Kannala-Brandt, and selection of an appropriate model may affect the quality of vision recognition.

The electronic device 101 according to an embodiment may obtain a 360-degree view image or night vision image that may not be input to a standard vision solution applied to a designated vision engine. According to conventional technology, when the electronic device 101 obtains visual data that is not of a designated type, such as a 360-degree view image or night vision image, through the first vision sensor 430 and/or the second vision sensor 450, it was difficult to use the designated vision engine using a standard vision solution. According to conventional technology, for the electronic device 101 to implement a vision engine corresponding to all types of visual data or all types of vision sensors, significant time and cost may be incurred.

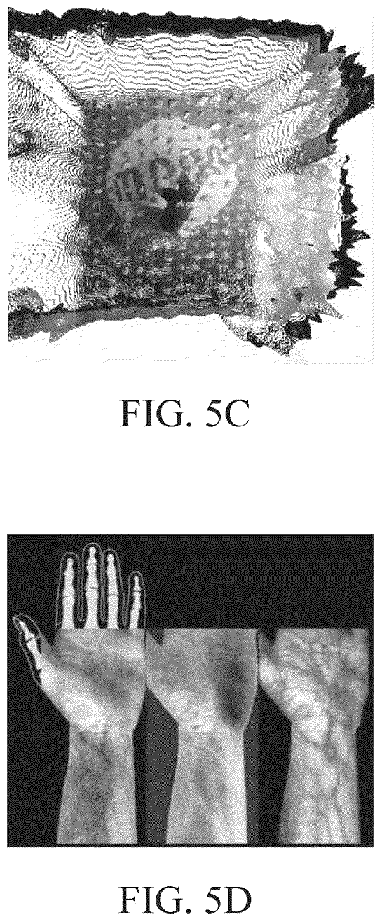

FIG. 6 illustrates adaptation of visual data according to an embodiment of the disclosure.

Referring to FIG. 6, the electronic device 101 according to an embodiment may provide a technique for pre-processing visual data from the first vision sensor 430 and/or the second vision sensor 450 to input to the designated vision engine and provide a vision recognition solution.

In an embodiment, the electronic device 101 may transform at least one component of visual data obtained from the first vision sensor 430 and/or the second vision sensor 450 to adapt correspondingly to a designated vision engine. In an embodiment, the electronic device 101 may preprocess visual data from the first vision sensor 430 and/or the second vision sensor 450 with a focus on function/data/requirement generalization.

Accordingly, the electronic device 101 may provide a precise and efficient vision recognition solution using a designated vision engine, independent of the type of visual data.

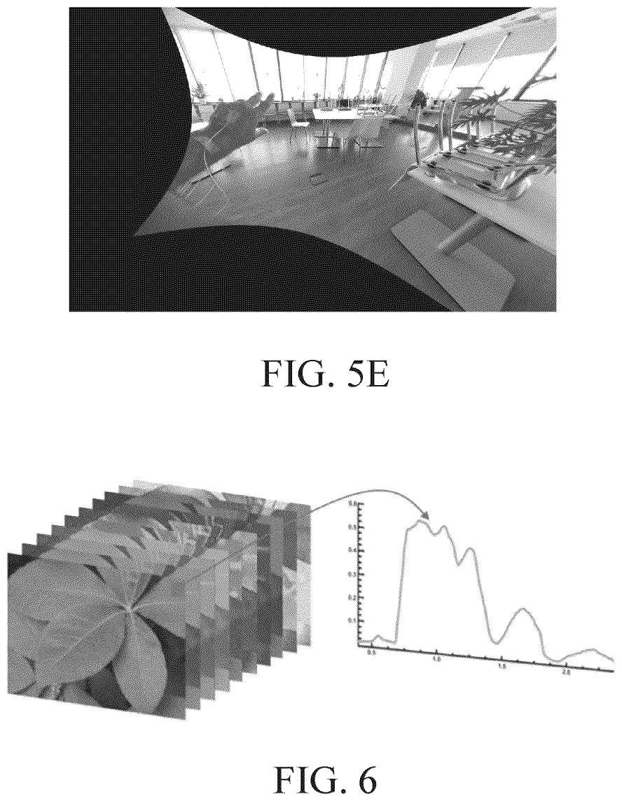

FIG. 7 is a flowchart illustrating an operating method of the electronic device 101 according to an embodiment of the disclosure.

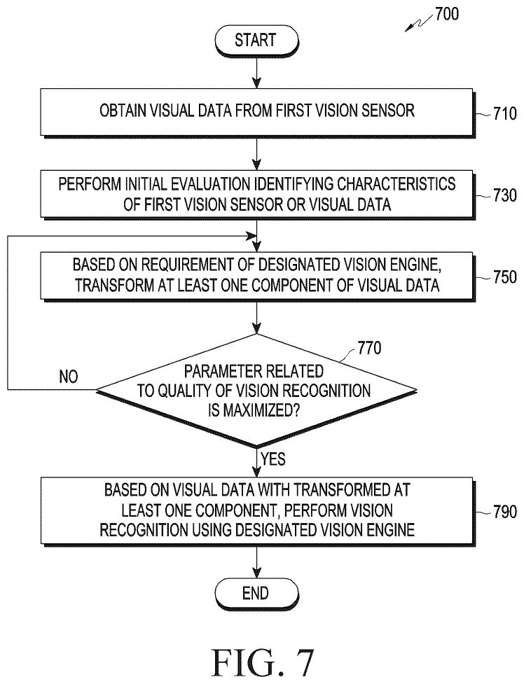

FIG. 8 is a flowchart illustrating the performing initial evaluation of FIG. 7 according to an embodiment of the disclosure.

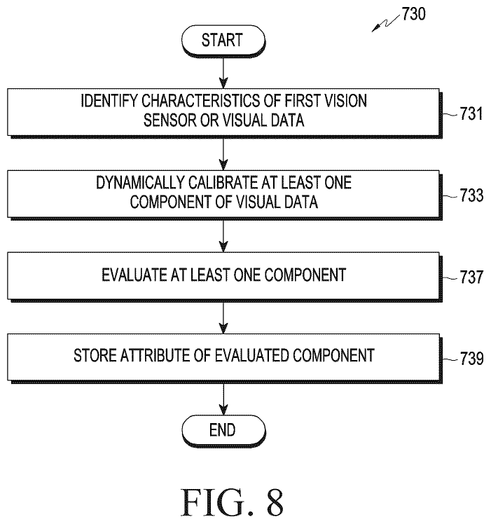

FIG. 9 is a flowchart illustrating the transforming at least one component of the visual data of FIG. 7 according to an embodiment of the disclosure.

Referring to FIG. 7, flowchart 700 illustrates that an electronic device 101 according to an embodiment may, in operation 710, obtain visual data from the first vision sensor 430.

The electronic device 101 according to an embodiment may obtain visual data using the first vision sensor 430 and/or the second vision sensor 450 for vision recognition using a designated vision engine. In an embodiment, the electronic device 101 may perform vision recognition for detection of a user's hand or recognition of a hand gesture. In an embodiment, the electronic device 101 may perform vision recognition for facial recognition, subject recognition, or map generation.

The first vision sensor 430 according to an embodiment may obtain visual data related to detection of a user's hand or recognition of a hand gesture. The electronic device 101 according to an embodiment may detect a user's hand based on a vision recognition result performed using visual data obtained from the first vision sensor 430. The electronic device 101 according to an embodiment may recognize a hand gesture based on a vision recognition result performed using visual data obtained from the first vision sensor 430.

The first vision sensor 430 according to an embodiment may obtain visual data related to facial recognition, subject recognition, or map generation. The electronic device 101 according to an embodiment may recognize a person's face or subject based on a vision recognition result performed using visual data obtained from the first vision sensor 430. The electronic device 101 according to an embodiment may generate a map through a simultaneous localization and map-building (SLAM) function based on a vision recognition result performed using visual data obtained from the first vision sensor 430.

The electronic device 101 according to an embodiment may, in operation 730, perform an initial evaluation identifying characteristics of the first vision sensor 430 or visual data.

Referring to FIG. 8, the electronic device 101 according to an embodiment may, as at least a part of performing initial evaluation, in operation 731, identify characteristics of the first vision sensor 430 or visual data. In an embodiment, the electronic device 101 may identify characteristics of the first vision sensor 430. For example, the electronic device 101 may identify the type, profile, and/or features of visual data output from the first vision sensor 430. In an embodiment, the electronic device 101 may identify characteristics of visual data.

The electronic device 101 according to an embodiment may, in operation 733, dynamically calibrate at least one component of visual data. In an embodiment, the electronic device 101 may dynamically calibrate at least one component dynamically based on the identified characteristics of the first vision sensor 430 or visual data.

The electronic device 101 according to an embodiment may, in operation 737, evaluate at least one component of visual data.

The electronic device 101 according to an embodiment may repeatedly execute operations 731, 733, and 737 at least once or more. In an embodiment, the electronic device 101 may repeat the operations to enhance the quality of evaluation.

The electronic device 101 according to an embodiment may, in operation 739, store an attribute of the evaluated component of visual data. For example, the electronic device 101 may store an evaluation result of at least one attribute of visual data corresponding to the first vision sensor 430 in memory (e.g., the memory 420 of FIG. 4).

Referring back to FIG. 7, the electronic device 101 according to an embodiment may, in operation 750, transform at least one component of visual data based on requirements of a designated vision engine.

In an embodiment, the electronic device 101 may identify requirements of a designated vision engine. For example, the electronic device 101 may identify requirements of the designated vision engine for the best quality of vision recognition. For example, the electronic device 101 may identify requirements of the designated vision engine based on at least one component corresponding to visual data used to train the designated vision engine.

In an embodiment, the electronic device 101 may adapt visual data obtained from the first vision sensor 430 to correspond to the identified requirements. In an embodiment, the electronic device 101 may transform visual data to another type according to the number of adaptation methods.

In an embodiment, the electronic device 101 may transform at least one component of visual data through methods of separating, integrating, resizing, and/or cropping an image to support various aspect ratios and resolutions.

In an embodiment, the electronic device 101 may transform visual data to correspond to another type of vision sensor. For example, the electronic device 101 may change visual data corresponding to a color image to a depth map, or transform visual data corresponding to a depth map to a color image.

In an embodiment, the electronic device 101 may change a color profile or parameters related to color of visual data. For example, the electronic device 101 may change grayscale visual data to RGB type. For example, the electronic device 101 may change RGB type visual data to hyperspectral type.

In an embodiment, the electronic device 101 may adjust a noise model of visual data. For example, a noise model may be particularly important for visual data used for SLAM or depth map generation.

In an embodiment, the electronic device 101 may adjust a distortion model of visual data. Further, the electronic device 101 may transform at least one component of visual data in addition to the examples described above.

Referring to FIG. 9, an electronic device 101 according to an embodiment may, as at least a part of transforming at least one component of visual data, in operation 753, identify a number or quality of at least one component of visual data.

In an embodiment, the electronic device 101 may identify a number of at least one component corresponding to visual data and identify quality corresponding to each. In an embodiment, the electronic device 101 may perform an evaluation operation multiple times based on the identified number of at least one component.

The electronic device 101 according to an embodiment may, in operation 755, evaluate a number or quality of at least one component based on requirements of a designated vision engine. In an embodiment, the electronic device 101 may generate a plan to adjust at least one component based on the number and/or quality of at least one component.

The electronic device 101 according to an embodiment may, in operation 757, transform at least one component based on an evaluation result.

In an embodiment, the electronic device 101 may change the resolution of visual data using a super resolution method.

In an embodiment, the electronic device 101 may adjust parameters related to color of visual data. For example, parameters related to color may include gamma, hue, or saturation.

In an embodiment, the electronic device 101 may geometrically transform visual data.

In an embodiment, the electronic device 101 may fuse visual data with another image. In an embodiment, the electronic device 101 may obtain comparison data corresponding to visual data from the second vision sensor 450 and fuse the obtained comparison data with visual data. For example, the comparison data may have at least a portion of one component of visual data different.

The electronic device 101 according to an embodiment may, in operation 770, identify whether a parameter related to quality of vision recognition is maximized.

The electronic device 101 according to an embodiment may, when a parameter related to quality of vision recognition is maximized (operation 770-Yes), in operation 790, perform vision recognition using the designated vision engine based on visual data with the transformed at least one component.

The electronic device 101 according to an embodiment may, when a parameter related to quality of vision recognition is not maximized (operation 770-No), repeat the operation 750 of transforming at least one component of visual data.

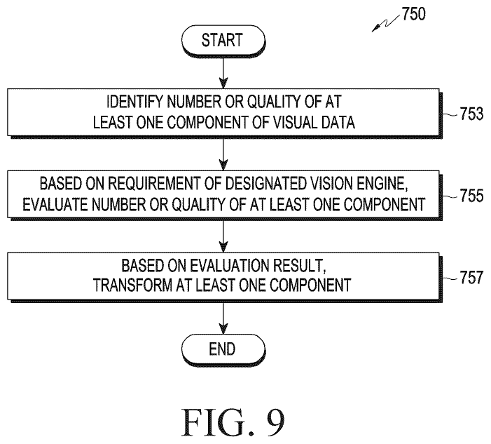

FIG. 10 illustrates an example of transforming a color profile of visual data according to an embodiment of the disclosure.

Referring to FIG. 10, visual data according to an embodiment may be obtained as a grayscale type. For example, the first vision sensor 430 may generate a grayscale type image.

The electronic device 101 according to an embodiment may variously adjust the color of visual data using a colorizer. For example, the electronic device 101 may adjust the color of visual data corresponding to each of a plurality of LEVELs (LEVEL 260, LEVEL 310, LEVEL 360, LEVEL 410, LEVEL 470).

In an embodiment, the electronic device 101 may extract parameters related to color using visual data with variously adjusted colors, respectively. In an embodiment, the electronic device 101 may maximize the number of parameters and obtain RGB parameters according to LEVEL. In an embodiment, the electronic device 101 may update and calibrate RGB parameters of visual data corresponding to parameter values according to LEVEL.

The electronic device 101 according to an embodiment may perform the colorization operation multiple times, and accordingly may transform grayscale type visual data to RGB type.

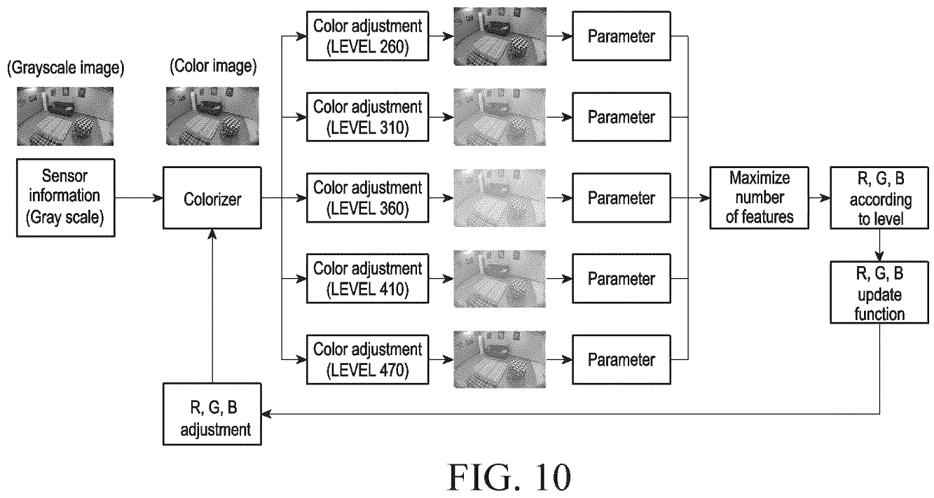

FIG. 11 illustrates an example of adjusting parameters related to color of visual data according to an embodiment of the disclosure.

Referring to FIG. 11, an electronic device 101 according to an embodiment may obtain an image frame from a first vision sensor 430. For example, the first vision sensor 430 may generate an RGB type image frame.

The electronic device 101 according to an embodiment may adjust parameters related to color of visual data based on a LEVEL corresponding to a designated vision engine. In an embodiment, the electronic device 101 may generate an image frame with adjusted parameters related to color for an input image frame.

In an embodiment, the electronic device 101 may adjust the Tone of an image frame. In an embodiment, the electronic device 101 may adjust the Curve of an image frame. In an embodiment, the electronic device 101 may adjust the Hue, Saturation, and/or Lightness of an image frame.

The electronic device 101 according to an embodiment may set a LEVEL for adjusting parameters related to color of visual data. In an embodiment, the electronic device 101 may set a LEVEL based on a designated vision engine. For example, a LEVEL may be set based on the purpose of a vision engine, such as whether the designated vision engine is for hand detection, for SLAM function, and/or for depth perception.

In an embodiment, the electronic device 101 may set a LEVEL according to characteristics of visual data (e.g., Shi-Tomasi, Fast9, Harris).

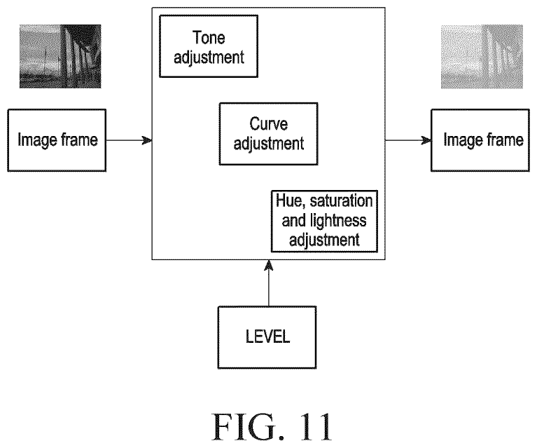

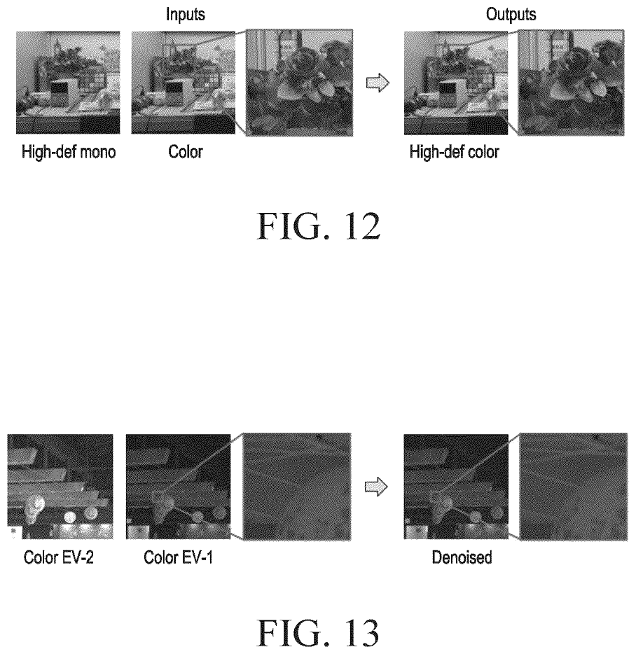

FIGS. 12 and 13 illustrate examples of fusing comparison data with visual data according to various embodiments of the disclosure.

Referring to FIGS. 12 and 13, an electronic device 101 according to an embodiment may further include a second vision sensor 450 separate from a first vision sensor 430. In an embodiment, the second vision sensor 450 may have at least a portion of at least one component different from visual data obtained from the first vision sensor 430.

In an embodiment, the first vision sensor 430 and the second vision sensor 450 may each obtain images of corresponding scenes. For example, the first vision sensor 430 and the second vision sensor 450 may each obtain differently disposed images of the same scene.

As illustrated in FIG. 12, the first vision sensor 430 and the second vision sensor 450 according to an embodiment may have different types of images obtained from each. For example, the first vision sensor 430 may be a monochrome camera configured to obtain monochrome images, and the second vision sensor 450 may be a color camera configured to obtain color images.

As illustrated in FIG. 13, the first vision sensor 430 and the second vision sensor 450 according to an embodiment may have the same type of images obtained from each. For example, both the first vision sensor 430 and the second vision sensor 450 may be high dynamic range (HDR) cameras that obtain high contrast images. In an embodiment, images obtained from the first vision sensor 430 and the second vision sensor 450 respectively may have at least one component different. For example, visual data from the first vision sensor 430 and comparison data from the second vision sensor 450 may have partially different exposure settings.

The electronic device 101 according to an embodiment may fuse visual data obtained through the first vision sensor 430 with comparison data obtained through the second vision sensor 450.

As illustrated in FIG. 12, the electronic device 101 according to an embodiment may transform a high-quality monochrome image obtained from the first vision sensor 430 into a high-quality color image by fusing it with a color image obtained from the second vision sensor 450.

As illustrated in FIG. 13, the electronic device 101 according to an embodiment may increase dynamic range and reduce noise by fusing a first HDR image obtained from the first vision sensor 430 with a second HDR image obtained from the second vision sensor 450.

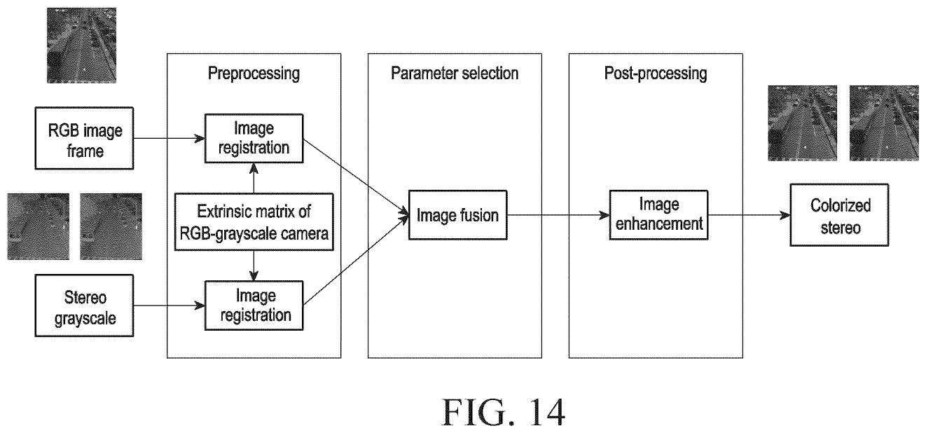

FIG. 14 illustrates an example of fusing comparison data with visual data according to an embodiment of the disclosure.

Referring to FIG. 14, an electronic device 101 according to an embodiment may obtain an RGB image frame from a first vision sensor 430. The electronic device 101 according to an embodiment may obtain a grayscale type stereo image frame from a second vision sensor 450.

The electronic device 101 according to an embodiment may pre-process the RGB image frame obtained from the first vision sensor 430 and the grayscale type stereo image frame obtained from the second vision sensor 450 for image registration, respectively. In an embodiment, the electronic device 101 may register each image frame based on extrinsic matrices of RGB-grayscale cameras.

The electronic device 101 according to an embodiment may fuse the RGB image frame obtained from the first vision sensor 430 with the grayscale type stereo image frame obtained from the second vision sensor 450.

The electronic device 101 according to an embodiment may post-process a fused image that fused the RGB image frame and the grayscale type stereo image frame.

The electronic device 101 according to an embodiment may transform into a colorized stereo image by fusing the RGB image frame obtained from the first vision sensor 430 with the grayscale type stereo image frame obtained from the second vision sensor 450.

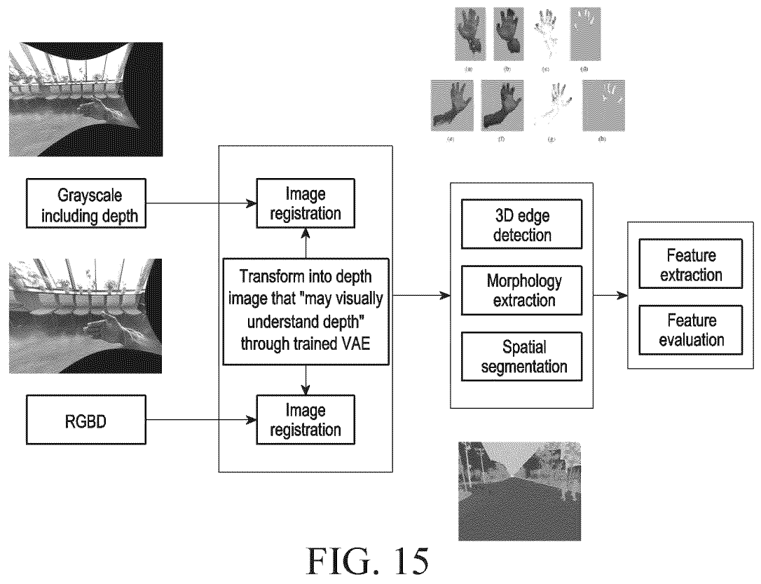

FIG. 15 illustrates an example of data transformation for an image according to an embodiment of the disclosure.

Referring to FIG. 15, an electronic device 101 according to an embodiment may generate depth data with at least one component of raw depth data transformed. For example, raw depth data may be obtained from various sources (e.g., various vision sensors).

In an embodiment, the designated vision engine of the electronic device 101 may be a vision engine for understanding an integrated spatial scene. In an embodiment, the designated vision engine of the electronic device 101 may be a vision engine for three dimensional (3D) edge detection, morphology extraction, and spatial segmentation.

The electronic device 101 according to an embodiment may obtain visual data from the first vision sensor 430 or the second vision sensor 450. In an embodiment, it may obtain a grayscale image including depth data. In an embodiment, the electronic device 101 may obtain a color image (e.g., red, green, blue, and depth (RGBD)). In an embodiment, the electronic device 101 may register each image obtained from the first vision sensor 430 or the second vision sensor 450.

The electronic device 101 according to an embodiment may transform a registered image including depth data into a depth image that may visually understand depth through a trained variational autoencoder (VAE).

The electronic device 101 according to an embodiment may transform at least one component based on requirements of the designated vision engine corresponding to 3D edge detection, morphology extraction, or spatial segmentation through the transformed depth image.

The electronic device 101 according to an embodiment may extract features from depth data adapted to transform at least one component, and/or evaluate features.

The electronic device 101 according to an embodiment may perform additional feature extraction from a reconstructed spatial scene. In an embodiment, the electronic device 101 may perform post-processing based on requests from other vision engines.

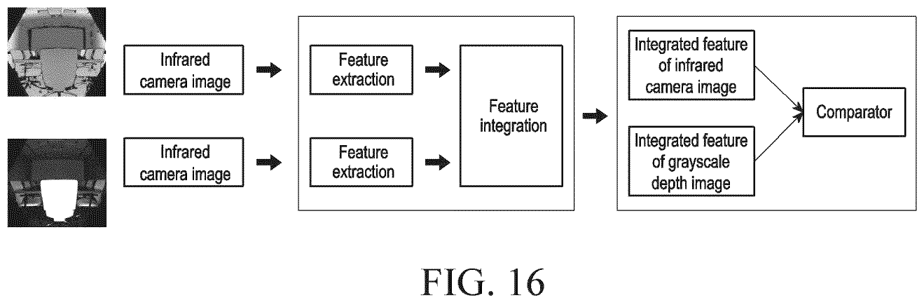

FIG. 16 illustrates an example of feature integration for evaluation of visual data according to an embodiment of the disclosure.

Referring to FIG. 16, an electronic device 101 according to an embodiment may extract features of visual data obtained from a first vision sensor 430 and/or a second vision sensor 450, and integrate the extracted features.

In an embodiment, the electronic device 101 may obtain an infrared camera image and a grayscale depth image respectively, and extract features from each obtained image. In an embodiment, the electronic device 101 may integrate features extracted from each image.

In an embodiment, as examples of feature integration, colorization, depth transformation, camera model transfer, separation and unification, and superpixel may be performed.

In an embodiment, the electronic device 101 may compare features of integrated images corresponding to each image through a comparator. In an embodiment, the electronic device 101 may compare features of integrated images at a semantic level for an application program interface (API) of a designated vision engine.

In an embodiment, the electronic device 101 may extract image features using a pre-trained network, and generate semantic latent vectors and residual latent vectors respectively using a semantic encoder and residual encoder. In an embodiment, the electronic device 101 may generate transformed image features using semantic latent vectors and residual latent vectors through a decoder.

In an embodiment, the electronic device 101 may extract semantic data from an image and compare the extracted semantic data. For example, a semantic encoder may capture data related to all attributes included in image features. For example, a residual encoder may capture data not related to attributes.

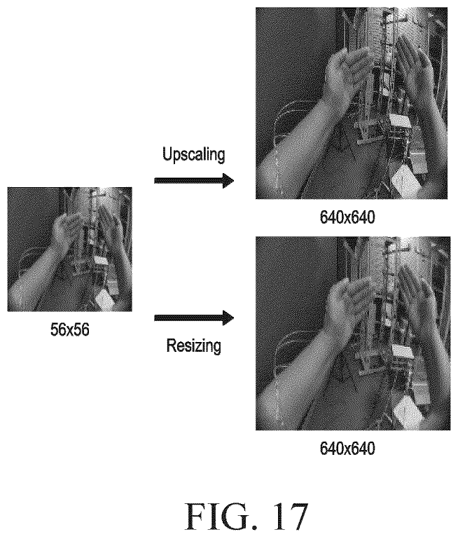

FIG. 17 illustrates an example of upscaling of an image according to an embodiment of the disclosure.

Referring to FIG. 17, an electronic device 101 according to an embodiment may transform at least one component to upscale visual data based on parameters related to a size corresponding to visual data.

In an embodiment, the electronic device 101 may obtain images of various sizes from the first vision sensor 430 and/or the second vision sensor 450. In an embodiment, the designated vision engine of the electronic device 101 may require a designated image size, and parameters related to image size may be included in requirements of the designated vision engine.

In an embodiment, the electronic device 101 may transform the size of an image by interpolating or resizing the obtained image. In this case, a problem may occur where features related to image quality deteriorate.

In an embodiment, the electronic device 101 may upscale the obtained image to maintain features related to image quality. For example, the electronic device 101 may adjust the size of an image using ESRGAN, an artificial intelligence-based upscaler. As illustrated in FIG. 17, when upscaling a 56×56 size image to 640×640 size, it may be identified that image quality was maintained compared to resizing.

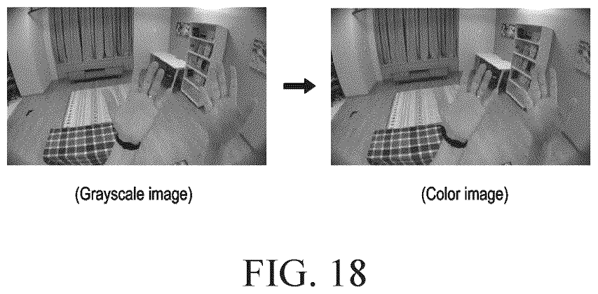

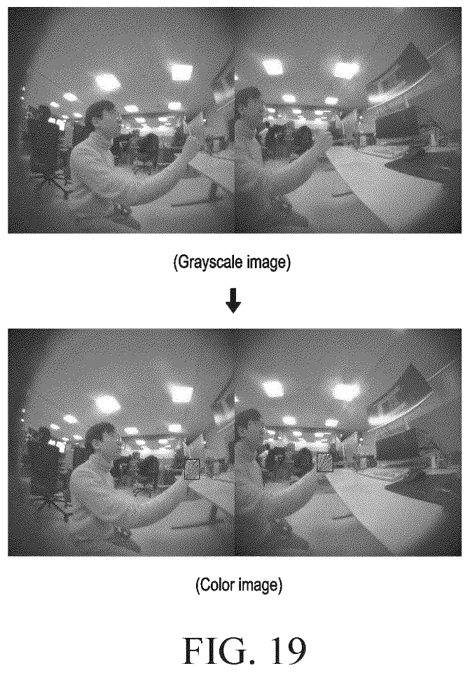

FIGS. 18 and 19 are examples of color adjustment and resulting hand detection according to various embodiments of the disclosure.

Referring to FIGS. 18 and 19, an electronic device 101 according to an embodiment may perform hand detection using a designated vision engine. For example, the designated vision engine may be trained with color images and may not work with monochrome images.

In an embodiment, the electronic device 101 may obtain a grayscale image from the first vision sensor 430 and/or the second vision sensor 450. In an embodiment, the electronic device 101 may transform the obtained grayscale image into a color image through colorization transformation. In an embodiment, the electronic device 101 may automatically perform colorization transformation based on requirements of a designated vision engine.

In an embodiment, the electronic device 101 may perform hand detection with the designated vision engine using the transformed color image. In an embodiment, the electronic device 101 could not detect a hand from a grayscale image due to the monochrome color profile, but may successfully detect a hand from a color image transformed through colorization transformation.

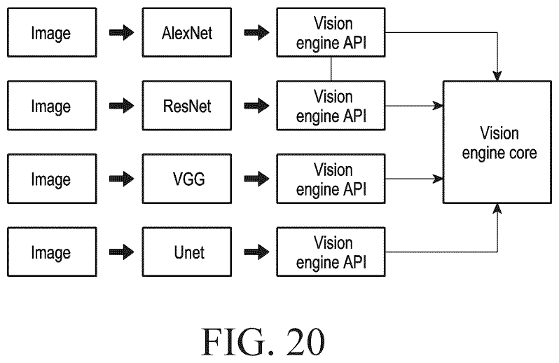

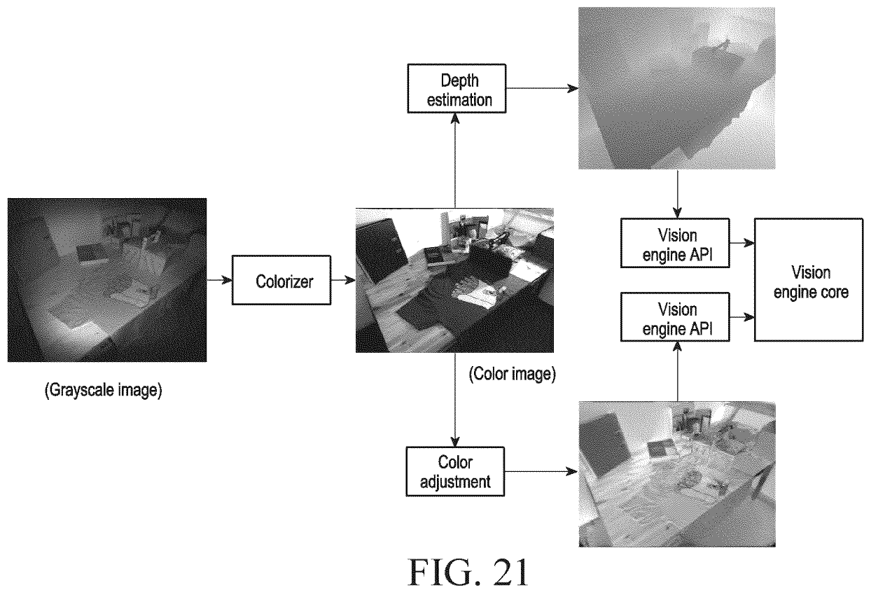

FIGS. 20 and 21 are examples of feature extraction and resulting vision recognition according to various embodiments of the disclosure.

Referring to FIGS. 20 and 21, an electronic device 101 according to an embodiment may extract at least one feature from visual data respectively. In an embodiment, the electronic device 101 may perform vision recognition based on the extracted at least one feature.

In an embodiment, the electronic device 101 may perform vision recognition using features extracted from convolution/pooling layers or variational autoencoder (VAE) instead of directly using visual data or images. For example, such algorithms may be used to collect pre-trained representations for arbitrary images.

In an embodiment, the electronic device 101 may extract one or more features from an image using various training models. For example, training models are exemplified as AlexNet, ResNet, VGG, Unet, but other training models may also be used.

In an embodiment, the electronic device 101 may process features obtained from an image using each training model through a vision engine API. In an embodiment, the electronic device 101 may perform vision recognition based on image features obtained from one or more vision engine APIs through a vision engine core.

The electronic device 101 according to an embodiment may perform vision recognition through pre-processing for a grayscale image to correspond to a designated vision engine, as illustrated in FIG. 21. The electronic device 101 according to an embodiment may extract each of a depth map and a color image from visual data through a designated vision engine, and perform vision recognition based on the depth map and color image.

In an embodiment, the electronic device 101 may obtain a grayscale image from the first vision sensor 430 or the second vision sensor 450. In an embodiment, the electronic device 101 may colorize the grayscale image obtained through a colorizer. In an embodiment, the electronic device 101 may generate a depth map estimating depth for the colorized image. In an embodiment, the electronic device 101 may adjust the color of the colorized image.

In an embodiment, the electronic device 101 may extract features of the generated depth map and color-adjusted image based on each vision engine API. In an embodiment, the electronic device 101 may perform vision recognition based on image features extracted through a core of a designated vision engine.

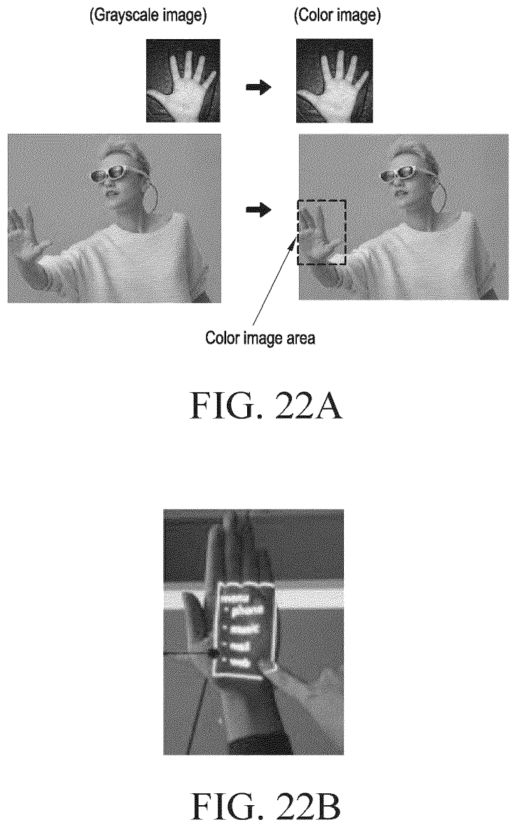

FIG. 22A illustrates an example of hand detection through vision recognition according to an embodiment of the disclosure. FIGS. 22B, 22C, and 22D are application examples of hand detection according to various embodiments of the disclosure.

Referring to FIGS. 22A, 22B, 22C, and 22D, an electronic device 101 according to an embodiment may provide content related to augmented reality (AR), virtual reality (VR), or extended reality (XR), and may receive interaction input according to a user's gesture.

In an embodiment, as illustrated in FIGS. 22B, 22C, and 22D, the electronic device 101 may display a designated screen on a tracked hand, receive game operation input through gestures, or provide edutainment according to gestures.

In an embodiment, the designated vision engine of the electronic device 101 may be based on a deep learning network and may be trained with color images. For example, the designated vision engine trained with color images may be more robust against many influences than features of grayscale images, as color-based calculated feature points or hand features from color images are learned based on light intensity.

The electronic device 101 according to an embodiment may include a first vision sensor 430 or second vision sensor 450 that obtains grayscale images rather than an RGB camera, considering the complexity of data processing and limited power consumption.

In an embodiment, the electronic device 101 may obtain a grayscale image from the first vision sensor 430 or the second vision sensor 450, transform the obtained grayscale image into a color image, and perform hand detection or gesture recognition through a designated vision engine.

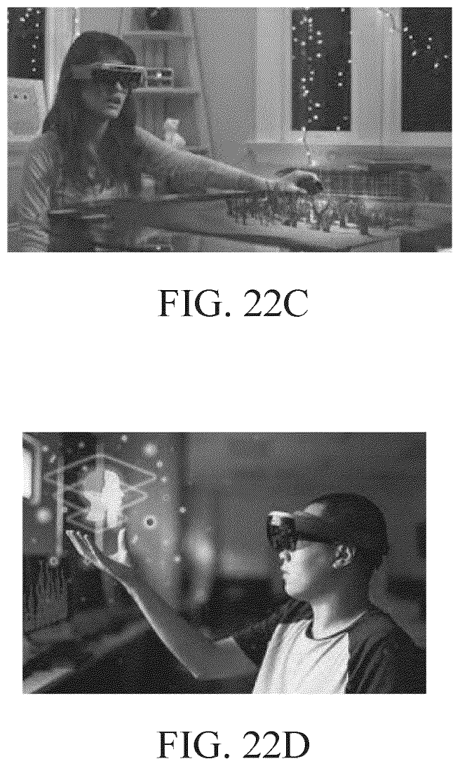

FIGS. 23A and 23B illustrate examples of facial recognition through vision recognition according to various embodiments of the disclosure.

Referring to FIGS. 23A and 23B, an electronic device 101 according to an embodiment may recognize a person's face from an obtained image and detect expressions from the recognized face.

In an embodiment, the electronic device 101 may recognize a person's face through the designated vision engine and recognize expressions from the recognized face. In an embodiment, the designated vision engine may be pre-trained to recognize expressions from facial images and may be pre-trained with color images. Face detection for expression recognition may show better effects in color images than grayscale images because skin color distribution and Laws texture energy in five color spaces are used to represent facial features.

In an embodiment, the electronic device 101 may obtain a grayscale image from the first vision sensor 430 or the second vision sensor 450, transform the obtained grayscale image into a color image, and perform facial recognition or expression detection through a designated vision engine.

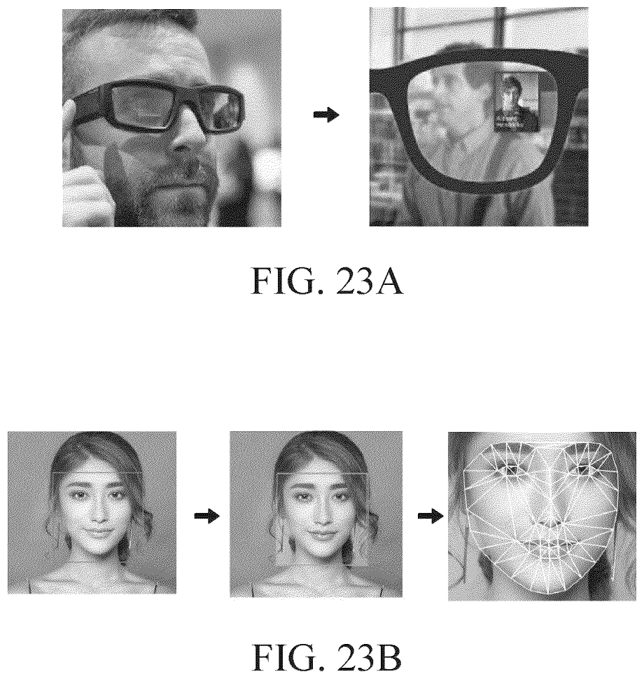

FIG. 24 illustrates an example of transforming visual data to correspond to requirements of a vision engine according to an embodiment of the disclosure.

Referring to FIG. 24, an electronic device 101 according to an embodiment may transform obtained visual data to correspond to requirements of a vision engine.

The electronic device 101 according to an embodiment may obtain an orthographic projection image from the first vision sensor 430 or the second vision sensor 450.

In an embodiment, the designated vision engine may require input of a fisheye projection image. In an embodiment, the designated vision engine may require input of a color image.

The electronic device 101 according to an embodiment may transform an orthographic projection image into a colorized fisheye projection image corresponding to requirements of a designated vision engine. In an embodiment, the electronic device 101 may use various image transformation methods.

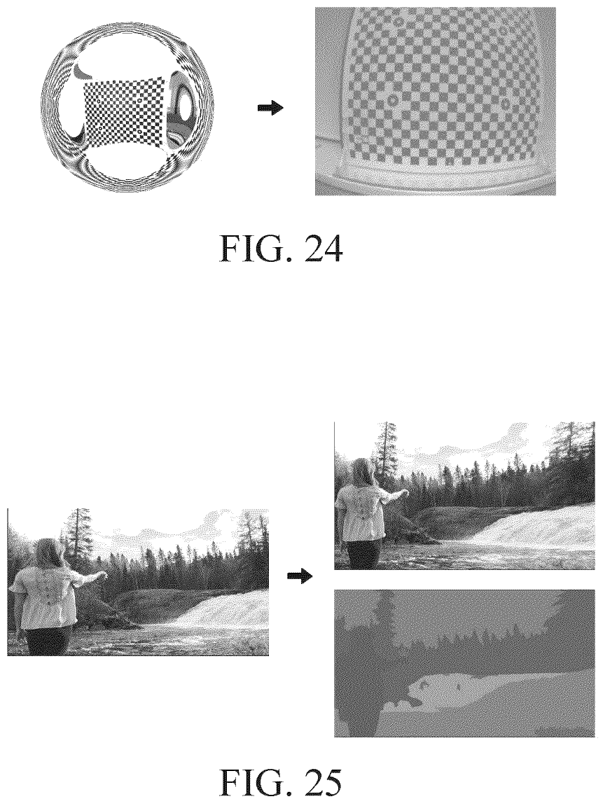

FIG. 25 illustrates an example of correcting a distortion model of visual data according to an embodiment of the disclosure.

Referring to FIG. 25, an electronic device 101 according to an embodiment may correct a distortion model of obtained visual data to correspond to requirements of a vision engine. In an embodiment, the designated vision engine may perform instance segmentation from an input image.

In an embodiment, the electronic device 101 may correct a distortion model of an image obtained from the first vision sensor 430 or the second vision sensor 450 corresponding to requirements of a designated vision engine. Accordingly, the quality of instance segmentation in the designated vision engine may be enhanced.

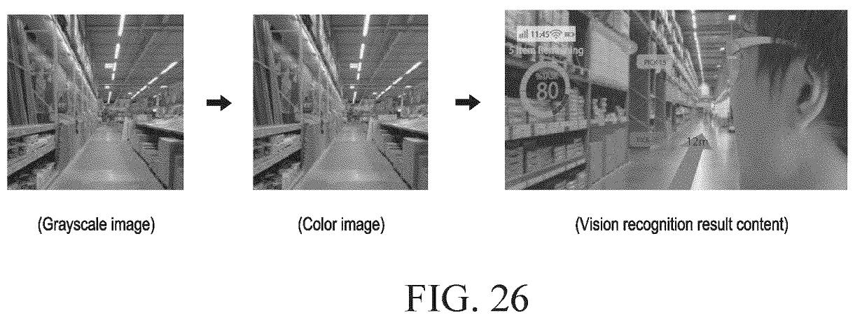

FIG. 26 illustrates an example of recognizing a subject according to an embodiment of the disclosure.

Referring to FIG. 26, an electronic device 101 according to an embodiment may obtain a grayscale image from a first vision sensor 430 or a second vision sensor 450. In an embodiment, the electronic device 101 may transform the obtained grayscale image into a color image.

The electronic device 101 according to an embodiment may recognize a subject through vision recognition using the transformed color image. In an embodiment, the electronic device 101 may detect a designated object through vision recognition.

The electronic device 101 according to an embodiment may provide content related to augmented reality (AR), virtual reality (VR), or extended reality (XR) displaying the result of vision recognition.

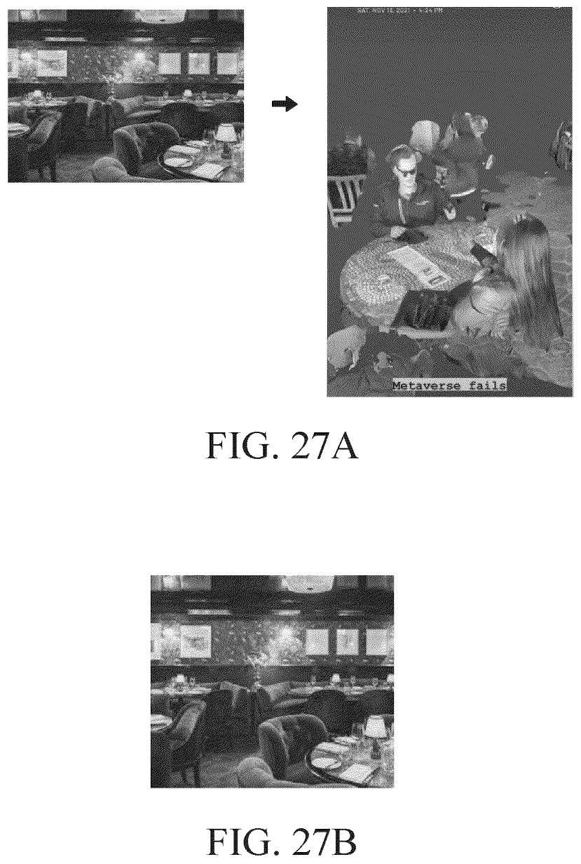

FIGS. 27A and 27B illustrate examples of providing a metaverse according to various embodiments of the disclosure.

Referring to FIGS. 27A and 27B, an electronic device 101 according to an embodiment may obtain a grayscale image and provide a metaverse based on the grayscale image. However, the electronic device 101 may generate a screen with broken rendering due to failure in 3D sensing by being based on grayscale.

The electronic device 101 according to an embodiment may collect different features for information about resolution, field of view, and optionally stereo lenses according to various types of cameras.

In an embodiment, it may transform one or more components of visual data obtained from a camera. The electronic device 101 according to an embodiment may output accurate rendering similar to an image of a real environment using a metaverse vision engine.

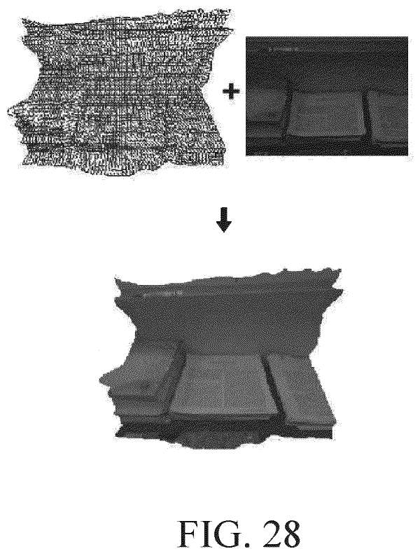

FIG. 28 illustrates an example of transformation to a point cloud according to an embodiment of the disclosure.

Referring to FIG. 28, an electronic device 101 according to an embodiment may transform a surface mesh or grayscale image into a point cloud using a designated algorithm.

In an embodiment, a designated algorithm may extract a concise 3D surface model of a scene from actual sensor data. In an embodiment, a designated algorithm may use a surface mesh describing registered images along with a scene as input. In an embodiment, a designated algorithm may output a surface mesh with fewer vertices and faces to which the shape of a scene is mapped.

In an embodiment, the electronic device 101 may generate an accurate and realistic description of a scene even in the presence of sensor noise, sparse data, and incomplete scene description, according to a designated algorithm.

In an embodiment, a generated point cloud may be used in a vision engine providing instance segmentation.

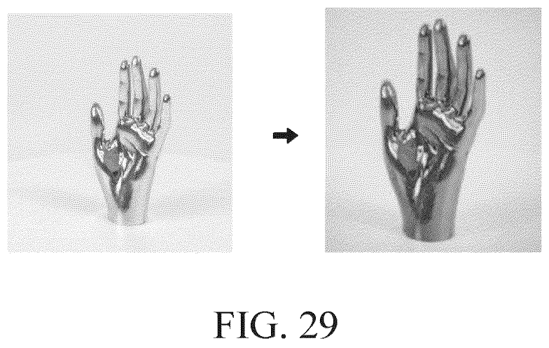

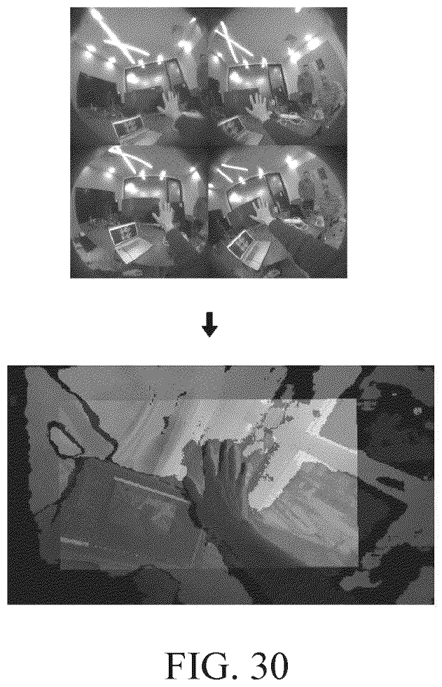

FIGS. 29 and 30 illustrate examples of transformation of visual data according to various embodiments of the disclosure.

Referring to FIGS. 29 and 30, in the case of automatic image enhancement according to a comparative embodiment, an image may be transformed to make the image sufficiently bright to a photographer's eyes (e.g., coloring and contrast of human faces, coloring of some objects (e.g., buildings outside a window), or correcting distorted faces to look more beautiful).

In contrast, the disclosure may aim for as many functions as possible, as textured scenes as possible, as non-uniform/non-homogeneous as possible, projection models, camera-specific distortion, and color characteristics for a vision engine of the electronic device 101.

According to the electronic device 101 according to an embodiment, as illustrated in FIG. 29, when illustrating a scene with strong colors or specific colors, a camera may react to this. The case regarding color is merely an example, and more complex cases may also be included.

In an embodiment, the electronic device 101 may include a depth camera, ToF camera, or stereo module for obtaining depth data. In an embodiment, the electronic device 101 may obtain depth data through matching in a mono camera.

In an embodiment, the electronic device 101 not including a depth camera may, as illustrated in FIG. 30, transform an obtained video stream to characteristics required by a vision engine corresponding to hand tracking. For example, a vision engine corresponding to hand tracking may be operated by colorized depth using a pinhole projection camera model. The electronic device 101 according to an embodiment may provide dynamic real-time stream characteristic transformation.

In the case of a camera system according to a comparative embodiment, only camera settings such as exposure, gain, white balance, and field of view (FoV) may be optimized to best suit machine vision tasks.

In contrast, the electronic device 101 according to an embodiment of the disclosure may estimate and adjust parameters in real-time during all task time based on an image transformation application, rather than in a pre-defined manner.

Accordingly, the electronic device 101 may track reactions to specific influences. For example, the camera system of the disclosure may track reactions corresponding to a television (TV) screen with an arbitrary subject (e.g., hand), an object with randomly changing colors, or any other influence on parameters (e.g., hand 3D pose, focal length, screen distortion, screen brightness).

The law of random parameter probability distribution for a system with this structure may be unique and identical in each implementation case. Therefore, whether the method of the disclosure has been implemented may be easily determined through comparative analysis between probability distributions of known output parameters and obtained output parameters (e.g., matrix values or hand 3D pose).

For example, a fixed random process (noise) with Gaussian distribution may follow the input of an algorithm, and such noise may be added to focal length values. Data may be collected according to the output of a calibration matrix, differential probability distributions may be constructed, and whether determined distribution laws and expected distribution laws converge may be identified using fitting criteria (e.g., chi-square test).

Technical objects to be achieved herein are not limited to the foregoing technical objects, and other technical objects not mentioned may be clearly understood by those skilled in the art from the following description.

Effects obtainable from the disclosure are not limited to the above-mentioned effects, and other effects not mentioned may be clearly understood by those skilled in the art from the following description.

An electronic device 101; 200; 300 according to an embodiment of the disclosure may include a first vision sensor 430; 176; 180 configured to obtain visual data, memory 420; 130 storing instructions, and at least one processor 410, 120. The instructions may, when executed by the at least one processor 410, 120, cause the electronic device 101; 200; 300 to obtain the visual data from the first vision sensor 430; 176; 180. The instructions may, when executed by the at least one processor 410, 120, cause the electronic device 101; 200; 300 to transform at least one component of the visual data based on a requirement of a designated vision engine. The instructions may, when executed by the at least one processor 410, 120, cause the electronic device 101; 200; 300 to perform vision recognition using the designated vision engine based on the visual data with the transformed at least one component.

In the electronic device 101; 200; 300 according to an embodiment, the first vision sensor 430; 176; 180 may be configured to obtain the visual data related to detection of a user's hand or recognition of a hand gesture.

In the electronic device 101; 200; 300 according to an embodiment, the first vision sensor 430; 176; 180 may be configured to obtain the visual data related to facial recognition, expression recognition, or map generation.

In the electronic device 101; 200; 300 according to an embodiment, the instructions may, when executed by the at least one processor 410, 120, cause the electronic device 101; 200; 300 to perform an initial evaluation identifying characteristics of the first vision sensor 430; 176; 180 or the visual data, and as at least a part of transforming the at least one component, identify or transform the at least one component based on a result of the initial evaluation.

In the electronic device 101; 200; 300 according to an embodiment, the instructions may, when executed by the at least one processor 410, 120, cause the electronic device 101; 200; 300 to, as at least a part of transforming the at least one component, identify a number or quality of the at least one component for the visual data, evaluate the number or quality of the at least one component based on the requirement of the designated vision engine, and transform the at least one component based on the evaluation result.

In the electronic device 101; 200; 300 according to an embodiment, the instructions may, when executed by the at least one processor 410, 120, cause the electronic device 101; 200; 300 to, as at least a part of transforming the at least one component, repeat transformation of the at least one component based on a parameter related to quality of the vision recognition.

In the electronic device 101; 200; 300 according to an embodiment, the at least one component of the visual data may include a parameter related to color of the visual data. The instructions may, when executed by the at least one processor 410, 120, cause the electronic device 101; 200; 300 to, as at least a part of transforming the at least one component, adjust the parameter related to the color.

The electronic device 101; 200; 300 according to an embodiment may further include a second vision sensor 450; 176; 180. The instructions may, when executed by the at least one processor 410, 120, cause the electronic device 101; 200; 300 to, as at least a part of transforming the at least one component, obtain, from the second vision sensor 450; 176; 180, comparison data corresponding to the visual data and with at least a portion of the at least one component being different, and fuse the obtained comparison data with the visual data.

In the electronic device 101; 200; 300 according to an embodiment, the at least one component of the visual data may include a parameter related to a size corresponding to the visual data. The instructions may, when executed by the at least one processor 410, 120, cause the electronic device 101; 200; 300 to, as at least a part of transforming the at least one component, upscale the visual data based on the parameter related to the size.

In the electronic device 101; 200; 300 according to an embodiment, the instructions may, when executed by the at least one processor 410, 120, cause the electronic device 101; 200; 300 to, as at least a part of performing vision recognition using the designated vision engine, extract each of at least one feature from the visual data, and perform, through the designated vision engine, the vision recognition based on the extracted at least one feature.

In the electronic device 101; 200; 300 according to an embodiment, the instructions may, when executed by the at least one processor 410, 120, cause the electronic device 101; 200; 300 to, as at least a part of performing vision recognition using the designated vision engine, extract each of a depth map and a color image from the visual data, and perform, through the designated vision engine, the vision recognition based on the depth map and the color image.

An operating method of an electronic device 101; 200; 300 according to an embodiment of the disclosure may include obtaining (e.g., in operation 710) visual data from a first vision sensor 430; 176; 180. The operating method of the electronic device 101; 200; 300 according to an embodiment may include transforming (e.g., in operation 750) at least one component of the visual data based on a requirement of a designated vision engine. The operating method of the electronic device 101; 200; 300 according to an embodiment may include performing (e.g., in operation 790) vision recognition using the designated vision engine based on the visual data with the transformed at least one component.

In the operating method of the electronic device 101; 200; 300 according to an embodiment, the visual data may be data related to detection of a user's hand, recognition of a hand gesture, facial recognition, expression recognition, or map generation.

The operating method of the electronic device 101; 200; 300 according to an embodiment may further include performing (e.g., in operation 730) an initial evaluation identifying characteristics of the first vision sensor 430; 176; 180 or the visual data. In the operating method of the electronic device 101; 200; 300 according to an embodiment, the transforming (e.g., in operation 750) the at least one component may identify or transform the at least one component based on a result of the initial evaluation.

In the operating method of the electronic device 101; 200; 300 according to an embodiment, the transforming (e.g., in operation 750) the at least one component may include identifying (e.g., in operation 753) a number or quality of the at least one component for the visual data, evaluating (e.g., in operation 755) the number or quality of the at least one component based on the requirement of the designated vision engine, and transforming (e.g., in operation 757) the at least one component based on the evaluation result.

In the operating method of the electronic device 101; 200; 300 according to an embodiment, the transforming (e.g., in operation 750) the at least one component may repeat transformation of the at least one component based on a parameter related to quality of the vision recognition.

In the operating method of the electronic device 101; 200; 300 according to an embodiment, the at least one component of the visual data may include a parameter related to color of the visual data. In the operating method of the electronic device 101; 200; 300 according to an embodiment, the transforming (e.g., in operation 750) the at least one component may include adjusting the parameter related to the color.

In the operating method of the electronic device 101; 200; 300 according to an embodiment, the transforming (e.g., in operation 750) the at least one component may obtain, from a second vision sensor 450; 176; 180, comparison data corresponding to the visual data and with at least a portion of the at least one component being different, and fuse the obtained comparison data with the visual data.

In the operating method of the electronic device 101; 200; 300 according to an embodiment, the at least one component of the visual data may include a parameter related to a size corresponding to the visual data. In the operating method of the electronic device 101; 200; 300 according to an embodiment, the transforming (e.g., in operation 750) the at least one component may upscale the visual data based on the parameter related to the size.

In the operating method of the electronic device 101; 200; 300 according to an embodiment, the performing (e.g., in operation 750) vision recognition using the designated vision engine may extract each of at least one feature from the visual data, and perform, through the designated vision engine, the vision recognition based on the extracted at least one feature.

In a storage medium storing computer-readable instructions according to an embodiment of the disclosure, the instructions, when executed by at least one processor 410; 120 of an electronic device 101; 200; 300, may cause the electronic device 101; 200; 300 to obtain the visual data from the first vision sensor 430; 176; 180. The instructions may, when executed by the at least one processor 410, 120, cause the electronic device 101; 200; 300 to transform at least one component of the visual data based on a requirement of a designated vision engine. The instructions may, when executed by the at least one processor 410, 120, cause the electronic device 101; 200; 300 to perform vision recognition using the designated vision engine based on the visual data with the transformed at least one component.

The electronic device according to an embodiment may be one of various types of electronic devices. The electronic devices may include, for example, a portable communication device (e.g., a smart phone), a computer device, a portable multimedia device, a portable medical device, a camera, an electronic device, or a home appliance. An electronic device according to an embodiment of the disclosure is not limited to the above-described devices.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first vision sensor configured to obtain visual data;
memory storing instructions; and
at least one processor,
wherein the instructions, when executed by the at least one processor individually or collectively, cause the electronic device to:
obtain the visual data from the first vision sensor,
based on a requirement of a designated vision engine, transform at least one component of the visual data, and
based on the visual data with the at least one component transformed, perform vision recognition using the designated vision engine.

2. The electronic device of claim 1, wherein the first vision sensor is further configured to obtain the visual data related to detection of a user's hand or recognition of a hand gesture.

3. The electronic device of claim 1, wherein the first vision sensor is further configured to obtain the visual data related to facial recognition, expression recognition, or map generation.

4. The electronic device of claim 1, wherein the instructions, further cause the electronic device to:
perform an initial evaluation identifying characteristics of the first vision sensor or the visual data; and
as at least part of the transforming of the at least one component, identify or transform the at least one component based on a result of the initial evaluation.

5. The electronic device of claim 1, wherein the instructions, further cause the electronic device to, as at least part of the transforming of the at least one component:
identify a number or quality of the at least one component for the visual data;
evaluate the number or quality of the at least one component based on the requirement of the designated vision engine; and
transform the at least one component based on a result of the evaluating.

6. The electronic device of claim 1, wherein the instructions, further cause the electronic device to:
as at least part of the transforming of the at least one component, repeat transforming of the at least one component based on a parameter related to quality of the vision recognition.

7. The electronic device of claim 1,
wherein the at least one component of the visual data includes a parameter related to color of the visual data, and
wherein the instructions, further cause the electronic device to:
as at least part of the transforming of the at least one component, adjust the parameter related to the color.

8. The electronic device of claim 1, further comprising:
a second vision sensor,
wherein the instructions, further cause the electronic device to, as at least part of the transforming of the at least one component:
obtain, from the second vision sensor, comparison data corresponding to the visual data and with at least a portion of the at least one component being different; and
fuse the comparison data with the visual data.

9. The electronic device of claim 1,
wherein the at least one component of the visual data includes a parameter related to a size corresponding to the visual data, and
wherein the instructions further cause the electronic device to:
as at least part of the transforming of the at least one component, upscale the visual data based on the parameter related to the size.

10. The electronic device of claim 1, wherein the instructions, further cause the electronic device to:
as at least part of the performing of vision recognition using the designated vision engine, extract each of at least one feature from the visual data and
perform, through the designated vision engine, the vision recognition based on the extracted at least one feature.

11. The electronic device of claim 10, wherein the instructions, further cause the electronic device to:
as at least part of the performing of the vision recognition using the designated vision engine, extract each of a depth map and a color image from the visual data; and
perform, through the designated vision engine, the vision recognition based on the depth map and the color image.

12. A method performed by an electronic device, the method comprising:
obtaining, by the electronic device, visual data from a first vision sensor;
based on a requirement of a designated vision engine, transforming, by the electronic device, at least one component of the visual data; and
based on the visual data with the at least one component transformed, performing, by the electronic device, vision recognition using the designated vision engine.

13. The method of claim 12, wherein the visual data includes data related to detection of a user's hand, recognition of a hand gesture, facial recognition, expression recognition, or map generation.

14. The method of claim 12, further comprising:
performing, by the electronic device, an initial evaluation identifying characteristics of the first vision sensor or the visual data,
wherein the transforming of the at least one component includes identifying or transforming, by the electronic device, the at least one component based on a result of the initial evaluation.

15. The method of claim 12, wherein the transforming of the at least one component includes:
identifying, by the electronic device, a number or quality of the at least one component for the visual data;
evaluating, by the electronic device, the number or quality of the at least one component based on the requirement of the designated vision engine; and
transforming, by the electronic device, the at least one component based on a result of the evaluating.

16. The method of claim 12, wherein the transforming of the at least one component includes repeating, by the electronic device, transforming of the at least one component based on a parameter related to quality of the vision recognition.

17. The method of claim 12,
wherein the at least one component of the visual data includes a parameter related to color of the visual data, and
wherein the transforming of the at least one component includes adjusting the parameter related to the color.

18. The method of claim 12, wherein the transforming of the at least one component includes:
obtaining, by the electronic device from a second vision sensor, comparison data corresponding to the visual data and with at least a portion of the at least one component being different; and
fusing, by the electronic device, the comparison data with the visual data.

19. The method of claim 12,
wherein the at least one component of the visual data includes a parameter related to a size corresponding to the visual data, and
wherein the transforming of the at least one component includes upscaling the visual data based on the parameter related to the size.

20. One or more non-transitory computer-readable storage media storing one or more computer programs including computer-executable instructions that, when executed by one or more processors of an electronic device individually or collectively, cause the electronic device to perform operations, the operations comprising:
obtaining, by the electronic device, visual data from a first vision sensor;
based on a requirement of a designated vision engine, transforming, by the electronic device, at least one component of the visual data; and
based on the visual data with the at least one component transformed, performing, by the electronic device, vision recognition using the designated vision engine.
